(19) United States
(12) Patent Application Publication
(10) Pub. No.: US 2006/0013097 A1
(43) Pub. Date: Jan. 19, 2006

(54) Method and apparatus for recording data on optical recording medium

(75) Inventors: Hironori Kakiuchi, Tokyo (JP); Hiroyasu Inoue, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/181,939

(22) Filed: Jul. 15, 2005

(30) Foreign Application Priority Data
Jul. 16, 2004 (JP) 2004-210234

(51) Int. Cl. G11B 20/10

(52) U.S. Cl. 369/59.1; 369/47.1

(57) ABSTRACT

An apparatus for recording data on an optical recording medium comprising a laser beam source 51 for emitting a laser beam, an objective lens, laser power control means 52 for modulating a power of the laser beam emitted from the laser beam source like a pulse between at least a recording power and a base power having a lower level than the recording power, a memory 55, and a control unit 50 for controlling a whole operation, wherein a timing for causing the power of the laser beam to rise to be the recording power when forming a longer recording mark than the shortest recording mark on a recording layer of the optical recording medium by using a laser beam modulated by a single pulse is delayed from a timing for causing the power of the laser beam to rise to be the recording power when forming the shortest recording mark and the control unit can build a recording strategy determined to form a recording mark on the recording layer based on ID data recorded on the optical recording medium stored in the memory.

### BACKGROUND OF THE INVENTION

The present invention relates to a method of recording data on an optical recording medium and an apparatus for recording data on an optical recording medium, and more particularly to a method of recording data on a write-once optical recording medium and an apparatus for recording data on a write-once optical recording medium which can reduce the jitter of a reproduced signal.

In recent years, optical recording media represented by a CD and a DVD have been utilized widely as recording media for recording digital data. These optical recording media can be roughly divided into ROM type optical recording media which can neither once write nor rewrite data, for example, a CD-ROM and a DVD-ROM, write-once optical recording media which can once write data but cannot rewrite data, for example, a CD-R and a DVD-R, and rewritable optical recording media capable of rewriting data, for example, a CD-RW and a DVD-RW.

In the ROM type optical recording media, generally, data are recorded by a prepit formed on a substrate in a manufacturing stage. In the rewritable optical recording media, generally, a phase change material is used as a material for a recording layer and data are recorded by utilizing a change in an optical characteristic which is caused by a change in the phase condition of the recording layer.

On the other hand, in the write-once optical recording media, an organic pigment such as a cyanine type pigment, a phthalocyanine type pigment or an azo pigment is generally used as the material for the recording material, and data are recorded by utilizing a change in an optical characteristic which is caused by a chemical change itself or a combination of a chemical change and a physical change.

Moreover, there has also been known a write-once optical recording medium in which two recording layers containing inorganic elements are laminated (for example, see JP-A-62-204442 publication). In the optical recording medium, a laser beam is irradiated to mix the inorganic elements constituting the two recording layers, thereby forming a region having a different optical characteristic from a surrounding region. Thus, data are recorded.

In this specification, in the case the optical recording medium includes a recording layer containing an organic pigment, a region in which the organic pigment is changed chemically or chemically and physically upon receipt of the irradiation of the laser beam is referred to as a “recording mark”. Whereas, in the case the optical recording medium includes two recording layers containing inorganic elements as principal components, a region in which the elements constituting the two recording layers are mixed upon receipt of the irradiation of the laser beam is referred to as the “recording mark”.

When the recording mark is to be formed on the recording layer of the optical recording medium to record data, a laser beam having a power modulated is irradiated on the recording layer in conformity to the recording mark to be formed.

A method of modulating the power of a laser beam to be irradiated for recording data is referred to as a recording strategy, and generally divides an nT signal (n is an integer of 2 to 8) into (n−1) pulses when forming a recording mark having a length corresponding to the nT signal on the recording layer of an optical recording medium in the case in which a (1, 7) RLL modulating system is used, for example, and sets the power of the laser beam to be a recording power Pw on the top of the pulse, and sets the power of the laser beam to be a base power Pb on the bottom of the pulse. Thus, the method of modulating the power of a laser beam is generally referred to as an (n−1) recording strategy.

[Patent Document 1] JP-A-62-204442 Publication

### DISCLOSURE OF THE INVENTION

### PROBLEMS THAT THE INVENTION IS TO SOLVE

In the case the nT signal is recorded on the optical recording medium, thus, the (n−1) recording strategy is generally used. If data are recorded on the optical recording medium at a high recording linear speed, it is difficult to divide the nT signal into the (n−1) pulses. Therefore, there has been proposed a recording strategy for modulating the power of a laser beam by using a single pulse when forming a recording mark having a length corresponding to a 2T signal and when forming a recording mark having a length corresponding to a 3T signal, while modulating the power of a laser beam by using two pulses when forming a recording mark having a length corresponding to a 4T signal and when forming a recording mark having a length corresponding to a 5T signal. Further, three pulses are used when forming a recording mark having a length corresponding to a 6T signal and when forming a recording mark having a length corresponding to a 7T signal, and four pulses are used when forming a recording mark having a length corresponding to an 8T signal.

In the case the power of the laser beam is modulated to record data on the recording layer of the optical recording medium in accordance with the recording strategy, however, the power of the laser beam is modulated by a single pulse in the same manner as in the case the recording mark having the length corresponding to the 2T signal is formed when the recording mark having the length corresponding to the 3T signal is to be formed. As compared with the case the recording mark having the length corresponding to the 2T signal is formed, therefore, a period for which the power of the laser beam is set to be the recording power Pw is necessarily longer than that in the case in which the recording marks having the lengths corresponding to the other signals are to be formed. As a result, the front part of the recording mark is influenced by a heat generated from the recording mark formed on the recording layer immediately before and is thus extended forward so that it is hard to form a recording mark having a desirable length. Consequently, there is a problem in that the jitter of a regenerated signal is increased.

In an optical recording medium comprising a plurality of recording layers, particularly, in the case in which the recording mark having the length corresponding to the 3T signal is to be formed on recording layers other than the most distant recording layer from a light incidence plane, there is a problem in that the front part of the recording mark is easily influenced by a heat from the recording mark formed on the recording layers immediately before so that the length of the recording mark is increased and the jitter of a regenerative signal is increased considerably.

More specifically, in the optical recording medium comprising a plurality of recording layers, the laser beam is transmitted through the recording layers other than the most distant recording layer from the light incidence plane on which a laser beam is incident when data are recorded on the most distant recording layer from the light incidence plane and the data thus recorded are reproduced. For this reason, the recording layers are necessitated to have a high light transmittance and a reflecting layer cannot be provided. In order to form the recording mark, accordingly, a heat generated by the laser beam irradiated on the region of the recording layer on which the recording mark is to be formed cannot be transmitted to the other regions through the reflecting layer so that the heat is stored in the region of the recording layer on which the recording layer is to be formed. For this reason, the front part of the recording mark is easily influenced by the heat generated from the recording mark formed on the recording layer immediately before. As a result, in the case in which the power of the laser beam is modulated by a single pulse to form the recording mark having the length corresponding to the 3T signal, particularly, there is a problem in that the length of the recording mark is easily increased and the jitter of a regenerative signal is deteriorated considerably.

### SUMMARY OF THE INVENTION

Accordingly, it is an object of the invention to provide a method of recording data on an optical recording medium and an apparatus for recording data on an optical recording medium which can reduce the jitter of a regenerative signal.

In order to attain the object of the invention, the inventor vigorously made studies repetitively and found the following as a result. More specifically, a timing for causing the power of a laser beam to rise to be a recording power when modulating the power of the laser beam by a single pulse to form a recording mark having a length corresponding to a 3T signal on the recording layer of an optical recording medium is delayed from a timing for causing the power of the laser beam to rise to be the recording power when forming a recording mark having a length corresponding to a 2T signal. Consequently, it is possible to effectively prevent the front part of the recording mark from being extended forward by the influence of a heat generated from the recording mark formed on the recording layer immediately before and to considerably reduce the jitter of a regenerative signal obtained by reproducing data which are recorded.

Therefore, the inventor further made studies continuously. As a result, the following was founded. More specifically, data are recorded on the recording layer of the optical recording medium at a higher recording linear speed, and the data thus recorded are reproduced to measure the jitter of a regenerative signal. Consequently, a timing for causing the power of the laser beam to rise to be a recording power when modulating the power of the laser beam by a single pulse to form a recording mark having a length corresponding to a 4T signal on the recording layer of the optical recording medium, when modulating the power of the laser beam by the single pulse to form a recording mark having a length corresponding to a 5T signal on the recording layer of the optical recording medium, and furthermore, when modulating the power of the laser beam by the single pulse to form a recording mark having a length corresponding to a 6T signal on the recording layer of the optical recording medium is delayed from a timing for causing the power of the laser beam to rise to be the recording power when forming the recording mark having the length corresponding to the 2T signal. Consequently, it is possible to effectively prevent the front part of the recording mark from being extended forward by the influence of the heat generated from the recording mark formed on the recording layer immediately before and to considerably reduce the jitter of a regenerative signal obtained by reproducing the recorded data. In the case in which the power of the laser beam is modulated by the single pulse to form a recording mark having a greater length than the shortest recording mark on the recording layer of the optical recording medium in order to record data at a high recording linear speed, a timing for causing the power of the laser beam to rise to be the recording power is delayed from a timing for causing the power of the laser beam to rise to be the recording power when forming the shortest recording mark. Consequently, it is possible to effectively prevent the front part of the recording mark from being extended forward by the influence of the heat generated from the recording mark formed on the recording layer immediately before and to considerably reduce the jitter of a regenerative signal obtained by reproducing the recorded data.

Accordingly, the object of the invention can be achieved by a method of recording data on an optical recording medium which irradiates a laser beam having a power modulated like a pulse between at least a recording power and a base power having a lower level than the recording power on the optical recording medium comprising a light transmitting layer and at least one recording layer from the light transmitting layer side and forms a recording mark having a different length on the at least one recording layer to record data, wherein a timing for causing the power of the laser beam to rise to be the recording power when forming a longer recording mark than the shortest recording mark on the at least one recording layer by using a laser beam modulated by a single pulse is delayed from a timing for causing the power of the laser beam to rise to be the recording power when forming the shortest recording mark, thereby forming the recording mark on the at least one recording layer.

According to the invention, in the case in which the longer recording mark than the shortest recording mark is formed on the recording layer to record data, it is possible to considerably reduce the jitter of a regenerative signal obtained by reproducing the data thus recorded.

In a preferred embodiment of the invention, the power of the laser beam is modulated among the recording power, the base power and an intermediate power having a level which is lower than the recording power and is higher than the base power.

In a preferred embodiment of the invention, the optical recording medium comprises a plurality of recording layers.

In a further preferred embodiment of the invention, at least the recording layers excluding the most distant recording layer from the light transmitting layer include a first recording film containing, as a principal component, an element selected from the group consisting of Si, Ge, Sn, Mg, In, Zn, Bi and Al and a second recording film provided in the vicinity of the first recording film and containing, as a principal component, an element selected from the group consisting of Cu, Al, Zn, Ti and Ag, and have such a structure that the element contained as the principal component in the first recording film and the element contained as the principal component in the second recording film are mixed to form a recording mark when a laser beam is irradiated.

The containment of a certain element as the principal component in the first recording film implies that the same element has the largest content in the elements contained in the first recording film. The containment of a certain element as the principal component in the second recording film implies that the same element has the largest content in the elements contained in the second recording film.

In a further preferred embodiment of the invention, it is preferable that the second recording film should be positioned in the vicinity of the first recording film to form a region in which the element contained as the principal component in the first recording film and the element contained as the principal component in the second recording film are mixed upon receipt of the irradiation of a laser beam. The second recording film does not need to come in contact with the first recording film and another film such as a dielectric film or more may be provided between the first recording film and the second recording film.

In a further preferred embodiment of the invention, the second recording film is formed in contact with the first recording film.

The reason why the element contained as the principal component in the first recording film and the element contained as the principal component in the second recording film are mixed to form the recording mark when a laser beam is irradiated is not always apparent. It can be guessed that the element contained as the principal component in the first recording film and the element contained as the principal component in the second recording film are molten or diffused partially or wholly when the laser beam is irradiated, and the element contained as the principal component in the first recording film and the element contained as the principal component in the second recording film are mixed to form the recording mark.

In a further preferred embodiment of the invention, the first recording film contains Si as a principal component and the second recording film contains Cu as a principal component.

In a further preferred embodiment of the invention, at least one element selected from the group consisting of Al, Zn, Sn, Mg and Au is added to the second recording film.

In a further preferred embodiment of the invention, a laser beam having a wavelength of 350 nm to 450 nm is irradiated to record data on the optical recording medium.

In another preferred embodiment of the invention, a laser beam is irradiated by using an objective lens having a numerical aperture NA to satisfy λ/NA≦640 nm and a laser beam having a wavelength λ through the objective lens, thereby recording data on the optical recording medium.

The object of the invention can also be achieved by an apparatus for recording data on an optical recording medium comprising a laser beam source for emitting a laser beam, an objective lens, laser power control means for modulating a power of the laser beam emitted from the laser beam source like a pulse between at least a recording power and a base power having a lower level than the recording power, a memory, and a control unit for controlling a whole operation, wherein a timing for causing the power of the laser beam to rise to be the recording power when forming a longer recording mark than the shortest recording mark on a recording layer of the optical recording medium by using a laser beam modulated by a single pulse is delayed from a timing for causing the power of the laser beam to rise to be the recording power when forming the shortest recording mark and the control unit can build a recording strategy determined to form a recording mark on the at least one recording layer based on ID data recorded on the optical recording medium stored in the memory.

In a preferred embodiment of the invention, the laser beam control means is constituted to modulate the power of the laser beam among the recording power, the base power and an intermediate power having a level which is lower than the recording power and is higher than the base power.

In a further preferred embodiment of the invention, the laser beam source is constituted to emit a laser beam having a wavelength of 350 nm to 450 nm.

In a further preferred embodiment of the invention, a wavelength λ of the laser beam emitted from the laser beam source and a numerical aperture NA of the objective lens satisfy λ/NA≦640 nm.

According to the invention, it is possible to provide a method of recording data on a write-once optical recording medium and an apparatus for recording data on a write-once optical recording medium which can reduce the jitter of a regenerative signal.

### BRIEF DESCRIPTION OF THE PREFERRED EMBODIMENTS

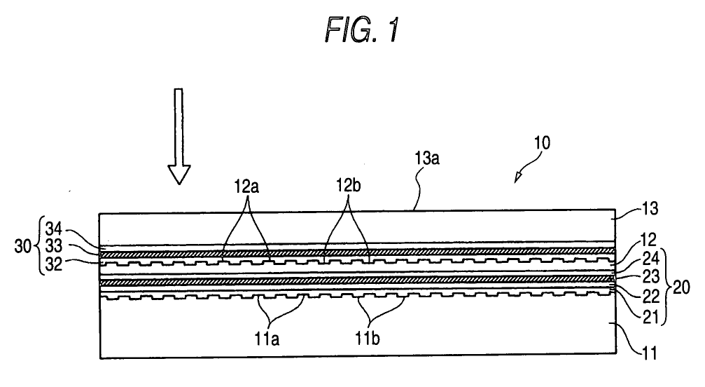

FIG. 1 is a schematic sectional view showing an optical recording medium for recording data by a method of recording data according to a preferred embodiment of the invention,

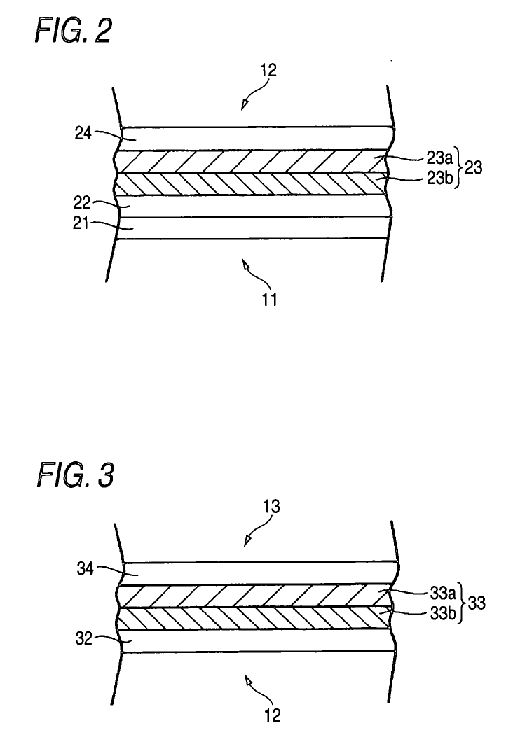

FIG. 2 is a schematic partial enlarged sectional view showing an L0 layer of the optical recording medium illustrated in FIG. 1,

FIG. 3 is a schematic partial enlarged sectional view showing an L1 layer of the optical recording medium illustrated in FIG. 1,

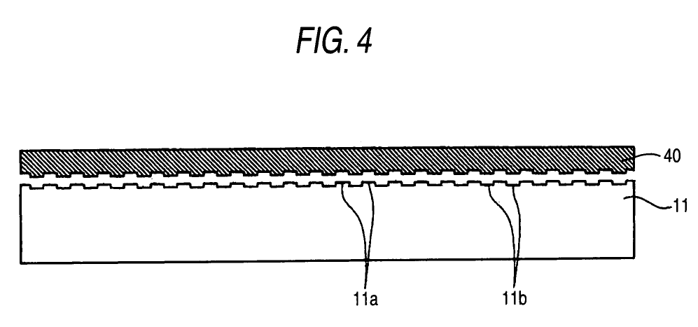

FIG. 4 is a view showing a process in a method of manufacturing the optical recording medium illustrated in FIG. 1,

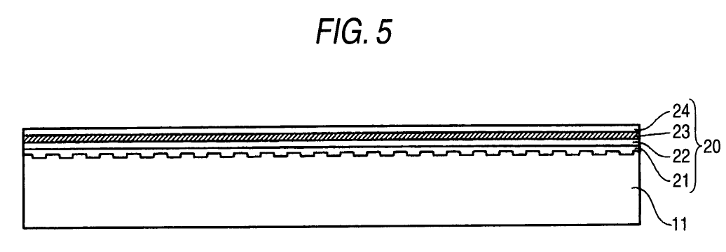

FIG. 5 is a view showing the process in the method of manufacturing the optical recording medium illustrated in FIG. 1,

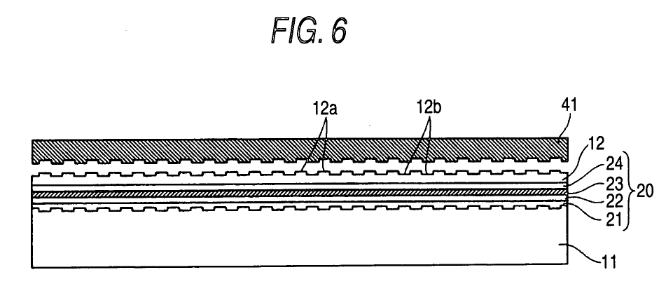

FIG. 6 is a view showing the process in the method of manufacturing the optical recording medium illustrated in FIG. 1,

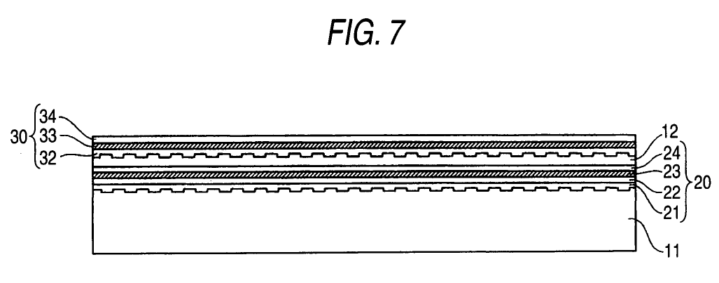

FIG. 7 is a view showing the process in the method of manufacturing the optical recording medium illustrated in FIG. 1,

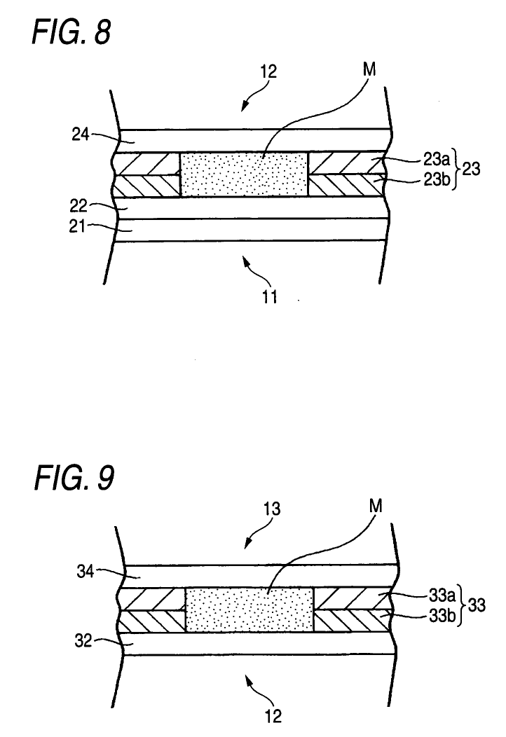

FIG. 8 is a schematic partial enlarged sectional view showing a state in which a recording mark is formed on the L0 recording layer of the optical recording medium,

FIG. 9 is a schematic partial enlarged sectional view showing a state in which a recording mark is formed on the L1 recording layer of the optical recording medium,

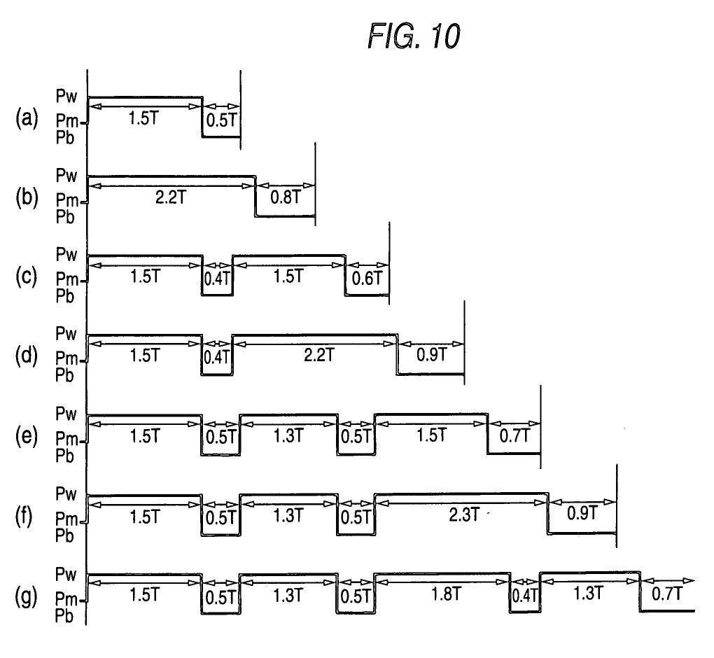

FIG. 10 is a diagram showing a recording strategy which has conventionally been used in the case in which data are to be recorded on the optical recording medium at a high recording linear speed by using a (1, 7) RLL modulating system,

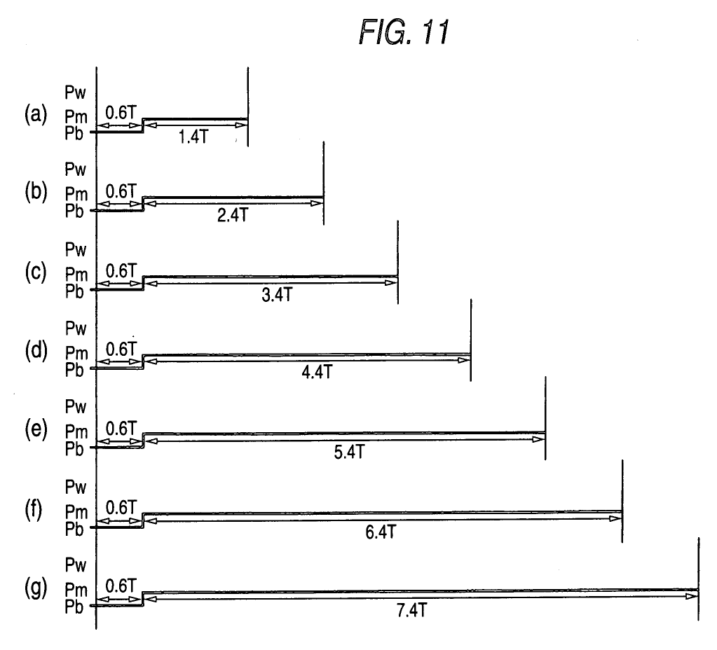

FIG. 11 is a diagram showing the recording strategy which has conventionally been used in the case in which data are to be recorded on the optical recording medium at a high recording linear speed by using the (1, 7) RLL modulating system,

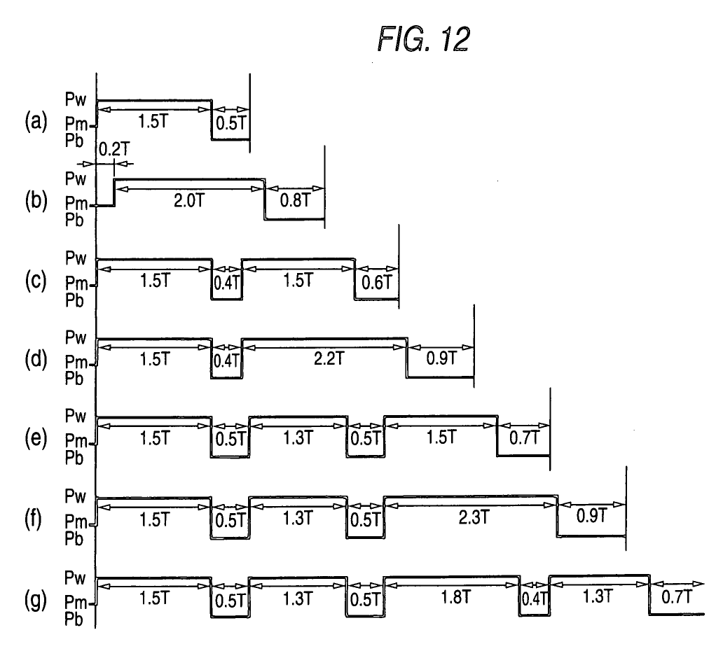

FIG. 12 is a diagram showing a recording strategy when data are to be recorded on the L1 recording layer or the L0 recording layer in the optical recording medium by using the (1, 7) RLL modulating system in a method of recording data according to a preferred embodiment of the invention,

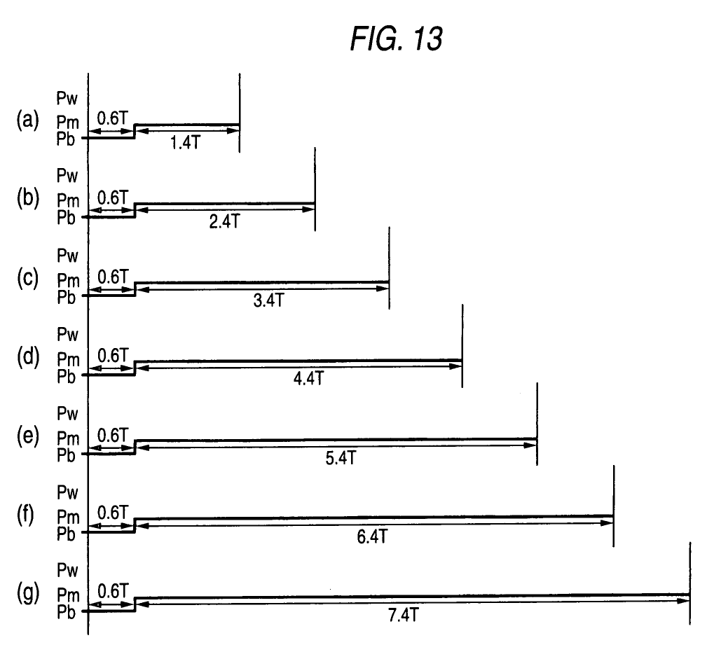

FIG. 13 is a diagram showing a recording strategy when data are to be recorded on the L1 recording layer or the L0 recording layer in the optical recording medium by using the (1, 7) RLL modulating system in a method of recording data according to a preferred embodiment of the invention,

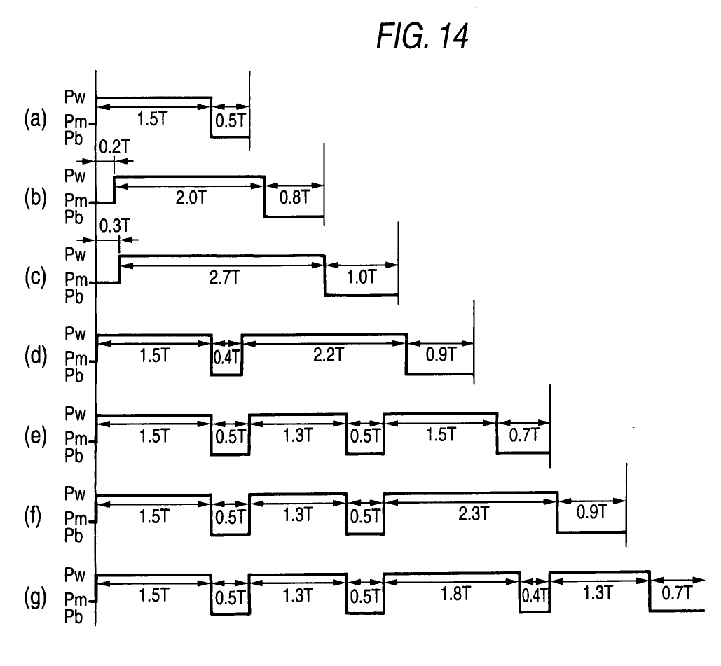

FIG. 14 is a diagram showing a recording strategy when data are to be recorded on the L1 recording layer or the L0 recording layer in the optical recording medium by using the (1, 7) RLL modulating system in a method of recording data according to another preferred embodiment of the invention,

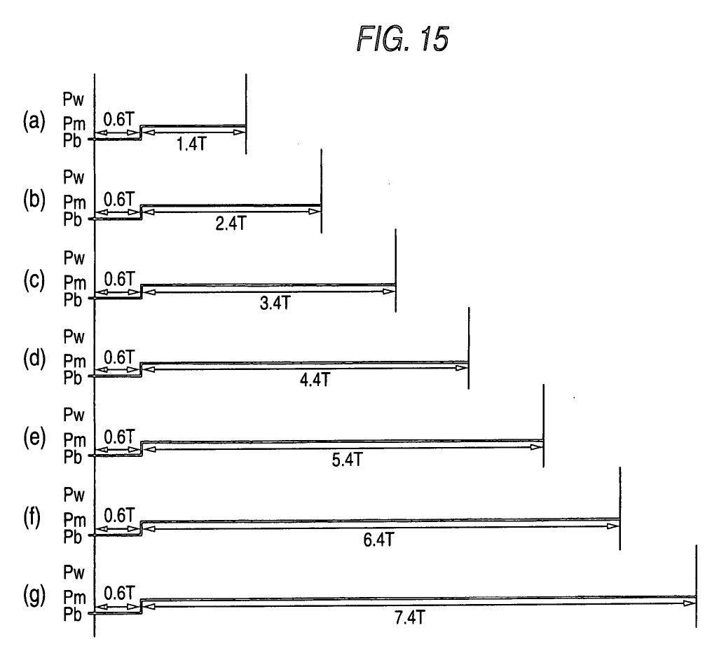

FIG. 15 is a diagram showing a recording strategy when data are to be recorded on the L1 recording layer or the L0 recording layer in the optical recording medium by using the (1, 7) RLL modulating system in a method of recording data according to a further preferred embodiment of the invention,

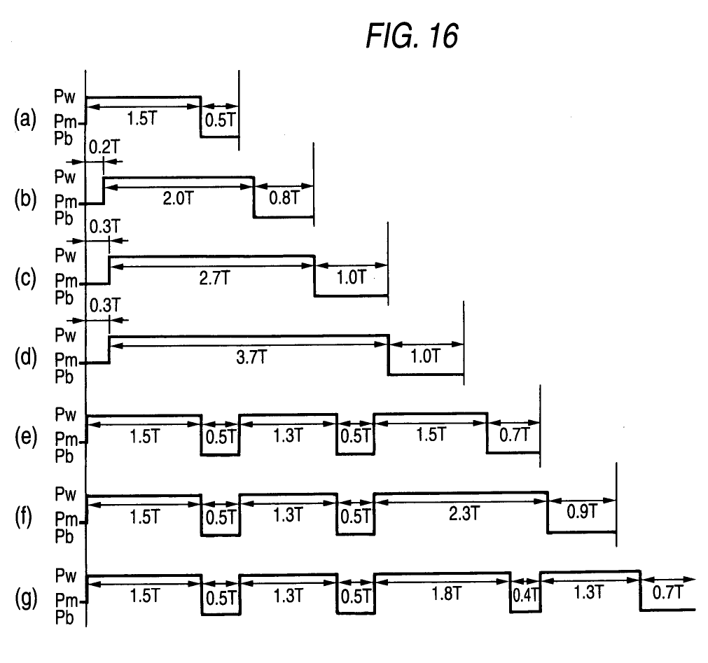

FIG. 16 is a diagram showing a recording strategy when data are to be recorded on the L1 recording layer or the L0 recording layer in the optical recording medium by using the (1, 7) RLL modulating system in a method of recording data according to a further preferred embodiment of the invention,

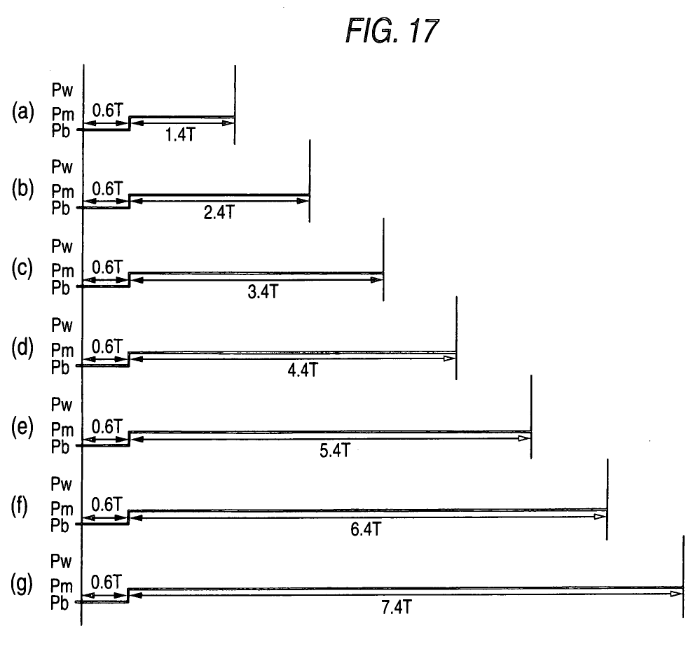

FIG. 17 is a diagram showing a recording strategy when data are to be recorded on the L1 recording layer or the L0 recording layer in the optical recording medium by using the (1, 7) RLL modulating system in a method of recording data according to a further preferred embodiment of the invention,

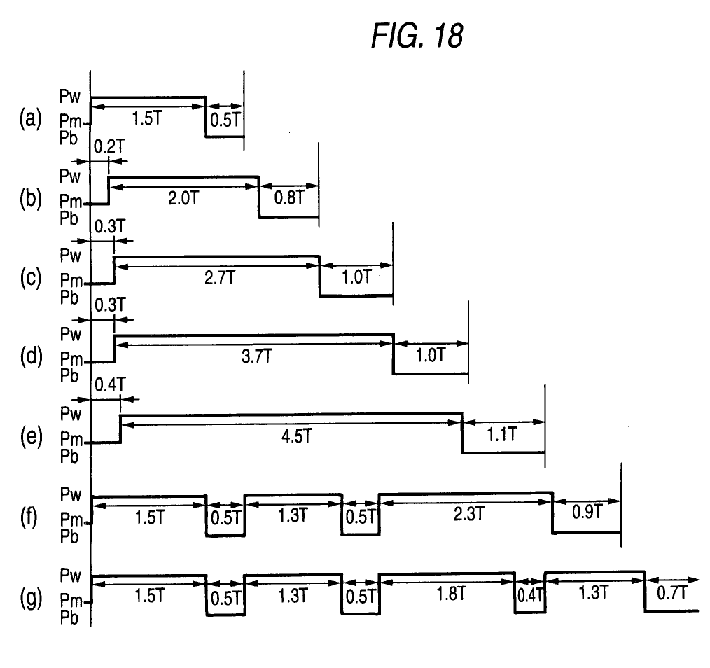

FIG. 18 is a diagram showing a recording strategy when data are to be recorded on the L1 recording layer or the L0 recording layer in the optical recording medium by using the (1, 7) RLL modulating system in a method of recording data according to a further preferred embodiment of the invention,

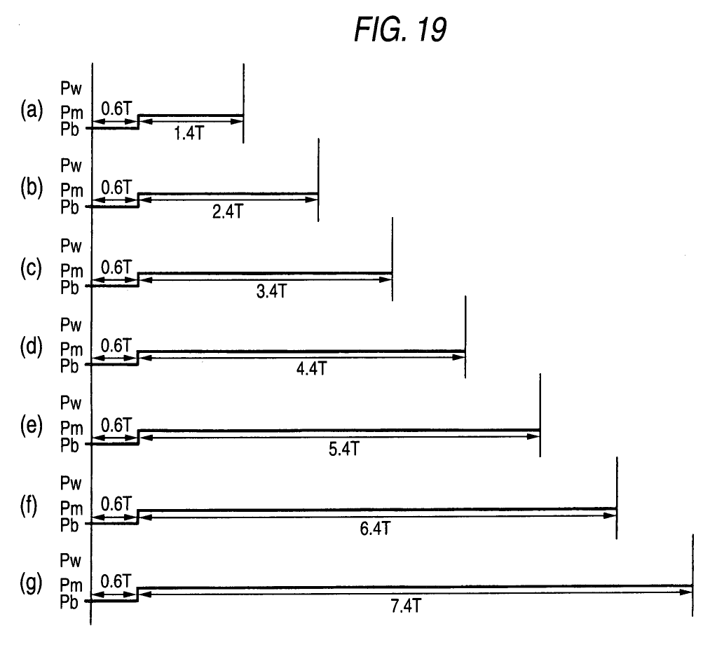

FIG. 19 is a diagram showing a recording strategy when data are to be recorded on the L1 recording layer or the L0 recording layer in the optical recording medium by using the (1, 7) RLL modulating system in a method of recording data according to a further preferred embodiment of the invention,

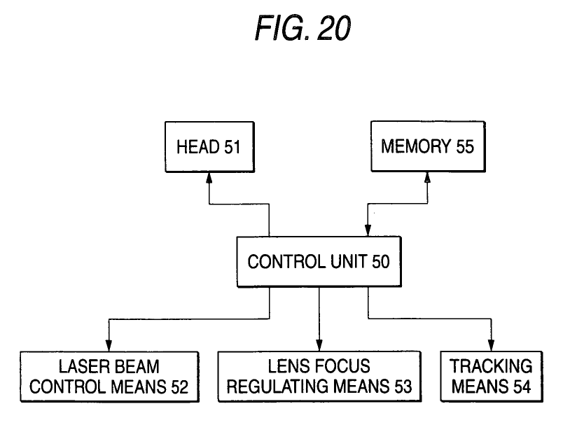

FIG. 20 is a block diagram showing a data recording apparatus according to a preferred embodiment of the invention,

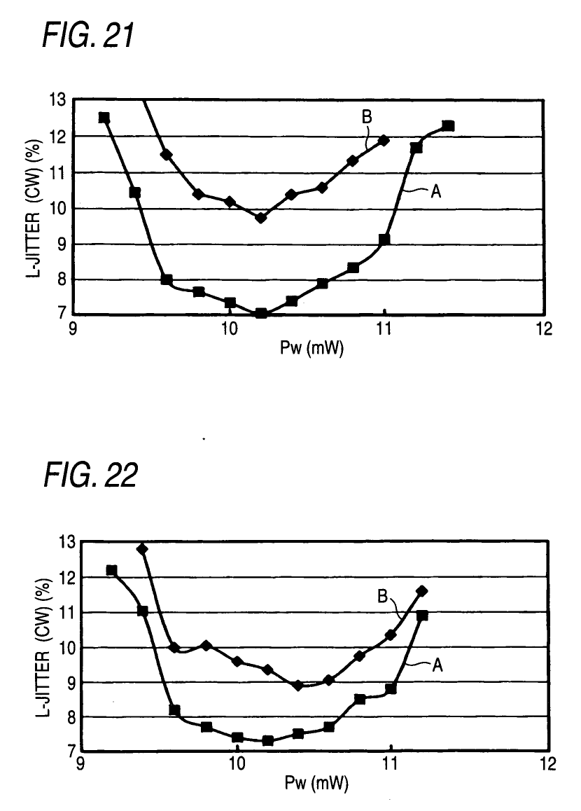

FIG. 21 is a graph showing a relationship between a jitter of a regenerative signal and a recording power Pw of a laser beam used for recording data according to an example 1 and a comparative example 1,

FIG. 22 is a graph showing a relationship between a jitter of a regenerative signal and a recording power Pw of a laser beam used for recording data in an example 2 and a comparative example 2,

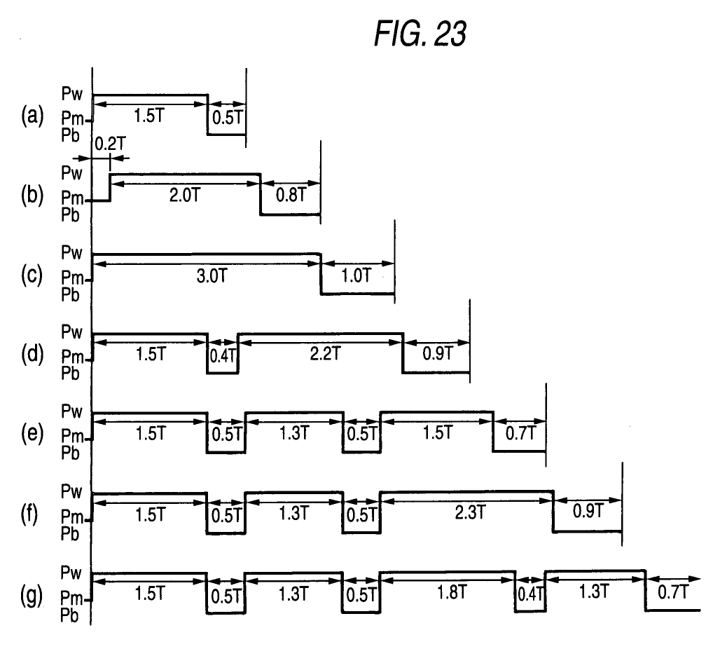

FIG. 23 is a diagram showing a recording strategy used for modulating the power of the laser beam according to the comparative example 2,

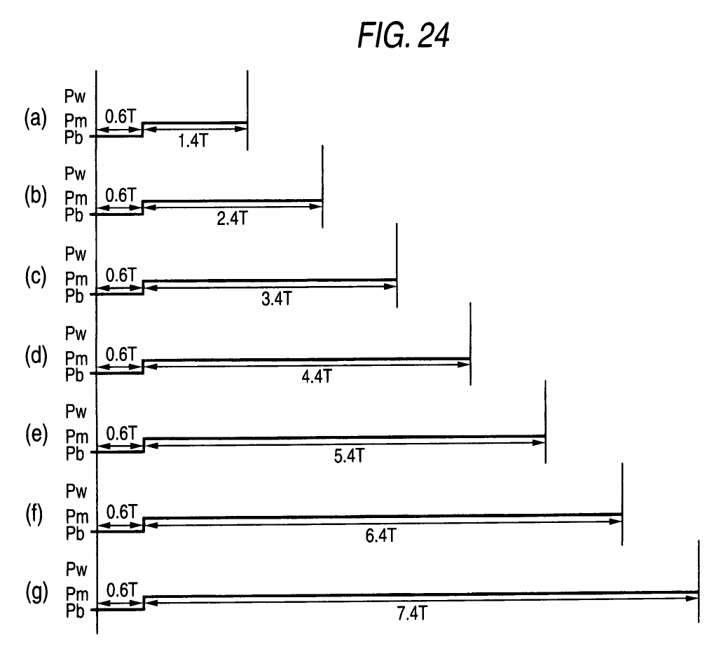

FIG. 24 is a diagram showing a recording strategy used for modulating the power of the laser beam according to the comparative example 2,

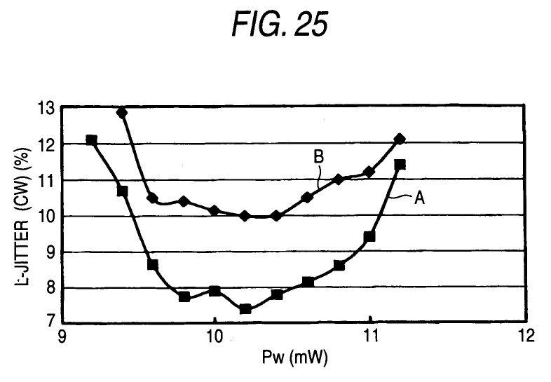

FIG. 25 is a graph showing a relationship between a jitter of a regenerative signal and a recording power Pw of a laser beam used for recording data according to an example 3 and a comparative example 3,

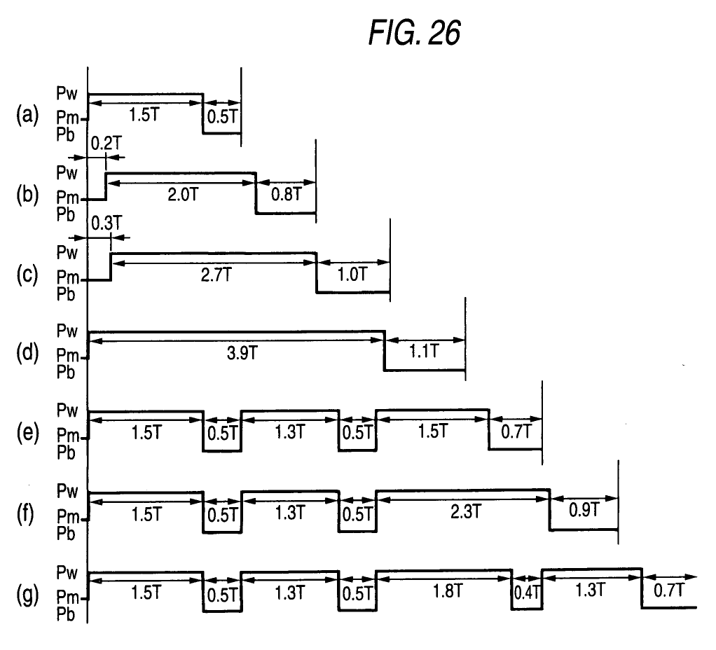

FIG. 26 is a diagram showing a recording strategy used for modulating the power of the laser beam according to the comparative example 3,

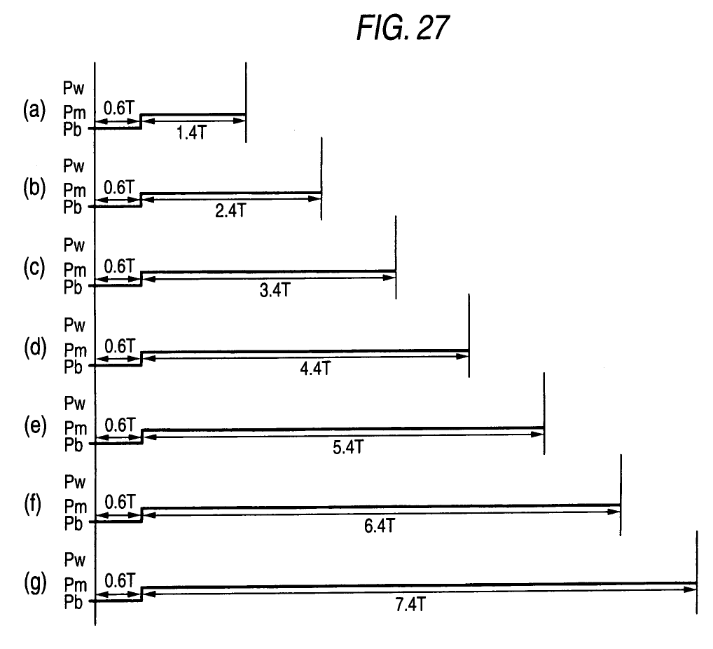

FIG. 27 is a diagram showing a recording strategy used for modulating the power of the laser beam according to the comparative example 3,

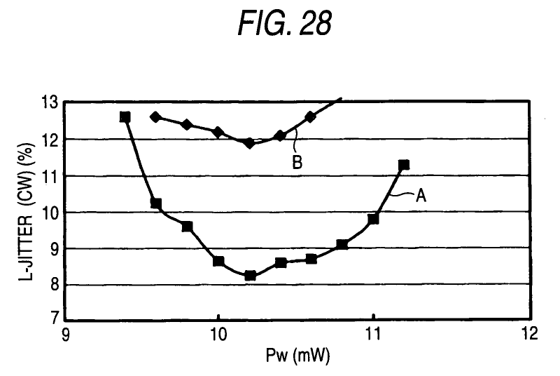

FIG. 28 is a graph showing a relationship between a jitter of a regenerative signal and a recording power Pw of a laser beam used for recording data according to an example 4 and a comparative example 4,

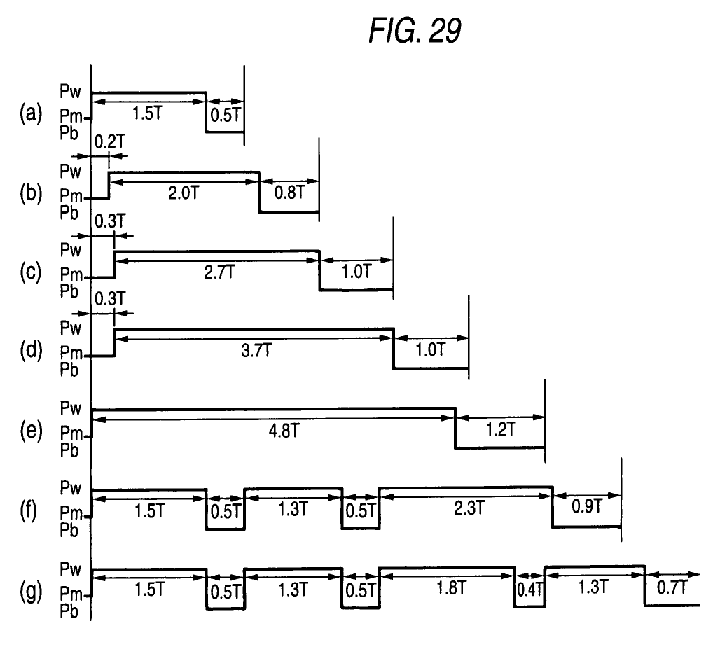

FIG. 29 is a diagram showing a recording strategy used for modulating the power of the laser beam according to the comparative example 4,

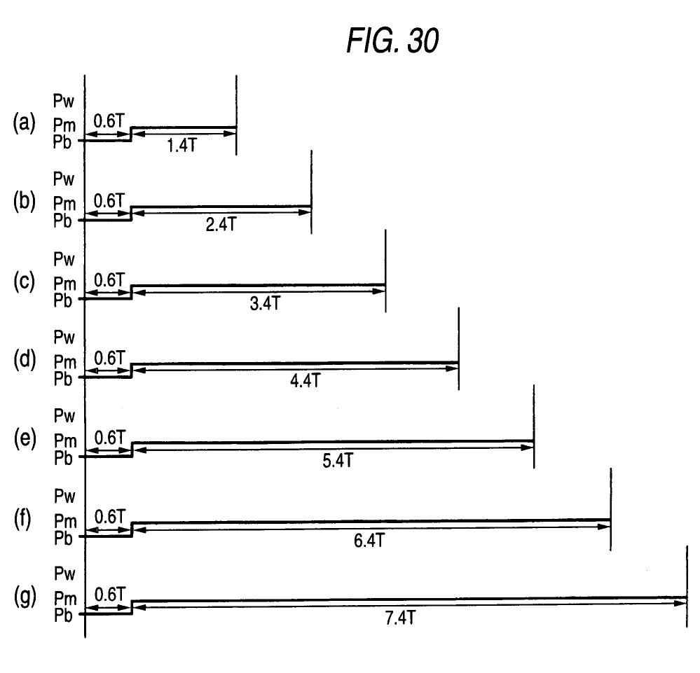

FIG. 30 is a diagram showing a recording strategy used for modulating the power of the laser beam according to the comparative example 4,

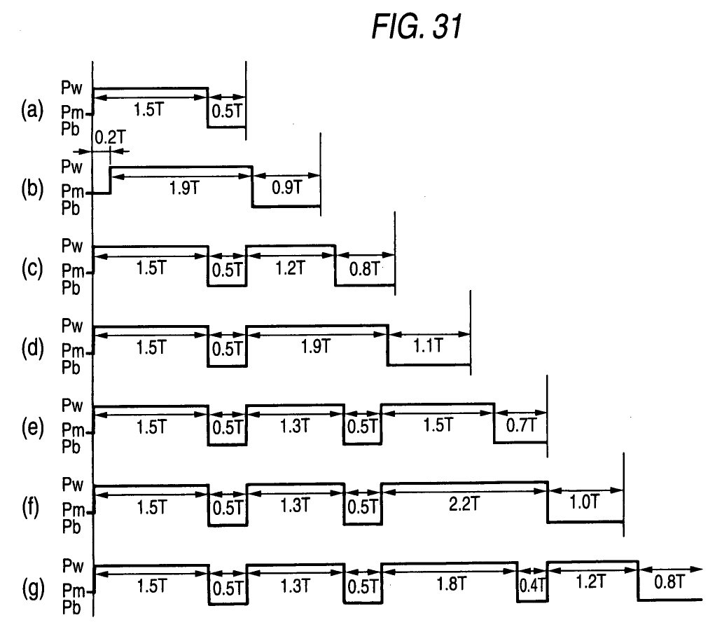

FIG. 31 is a diagram showing a recording strategy used for modulating the power of a laser beam according to an example 5,

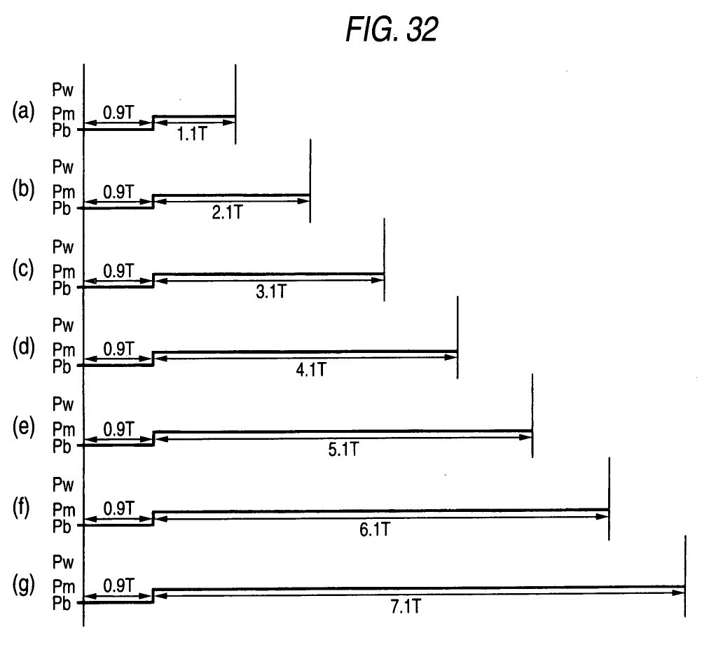

FIG. 32 is a diagram showing a recording strategy used for modulating the power of the laser beam according to the example 5,

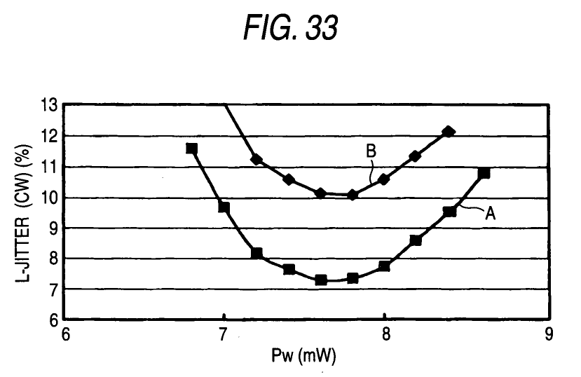

FIG. 33 is a graph showing a relationship between a jitter of a regenerative signal and a recording power Pw of a laser beam used for recording data according to the example 5 and a comparative example 5,

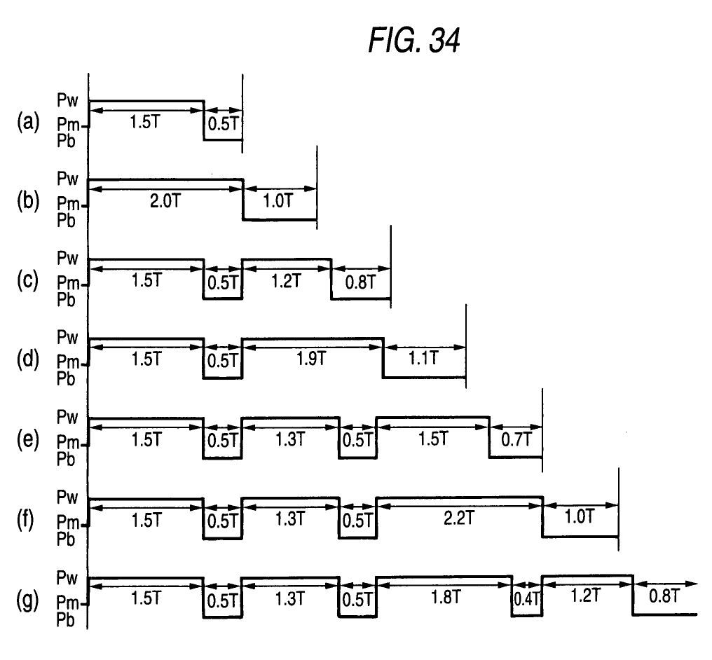

FIG. 34 is a diagram showing a recording strategy used for modulating the power of the laser beam according to the comparative example 5,

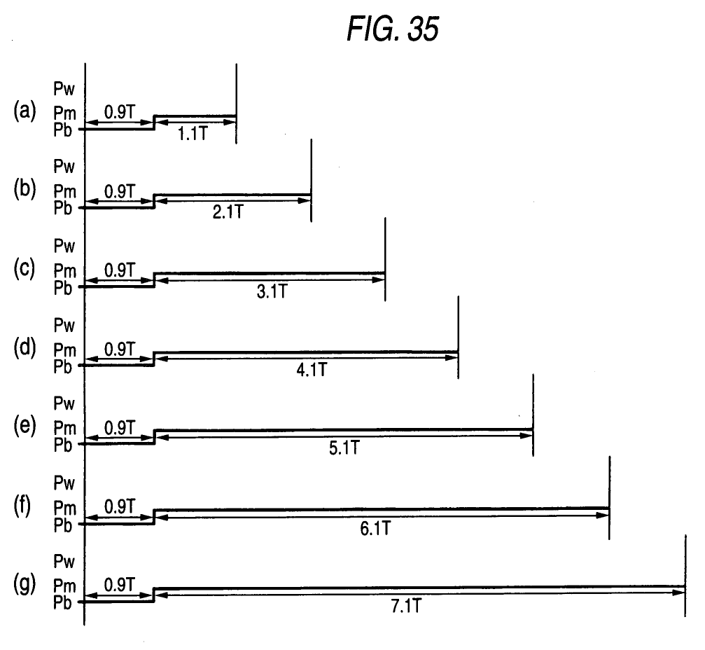

FIG. 35 is a diagram showing a recording strategy used for modulating the power of the laser beam according to the comparative example 5,

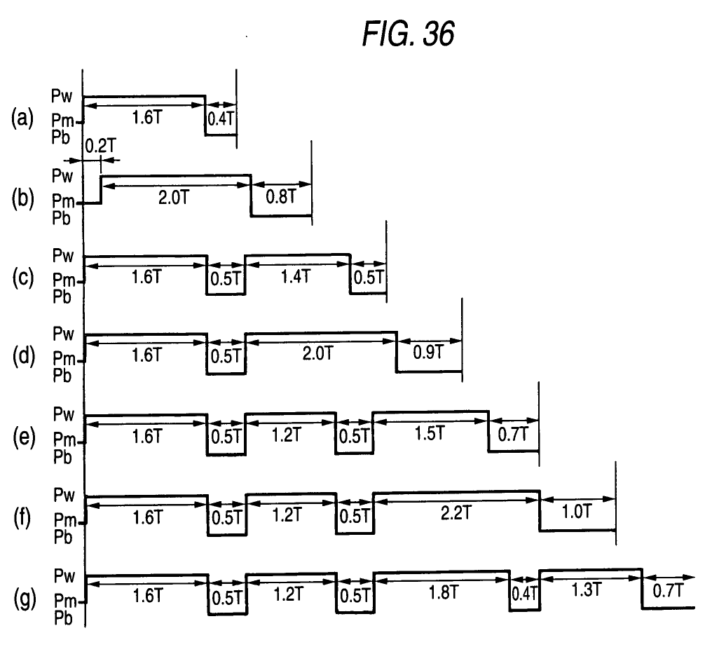

FIG. 36 is a diagram showing a recording strategy used for modulating the power of a laser beam according to an example 6,

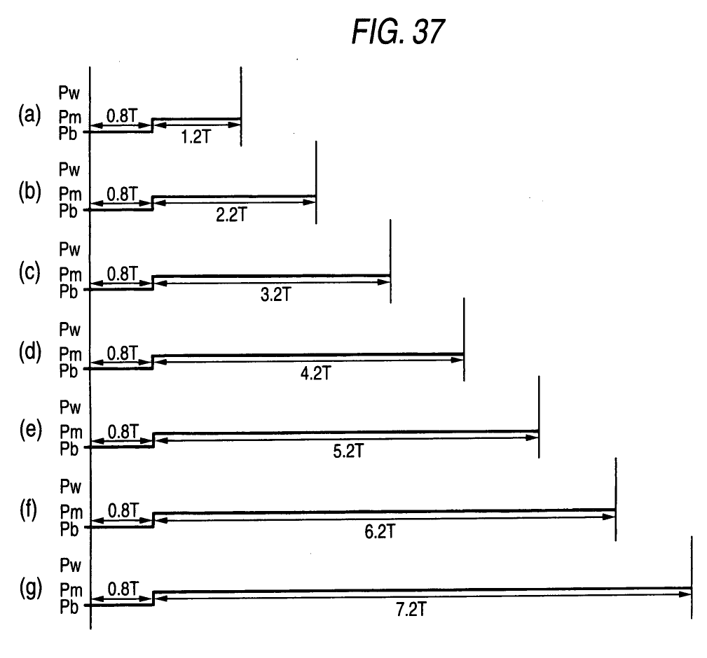

FIG. 37 is a diagram showing a recording strategy used for modulating the power of the laser beam according to the example 6,

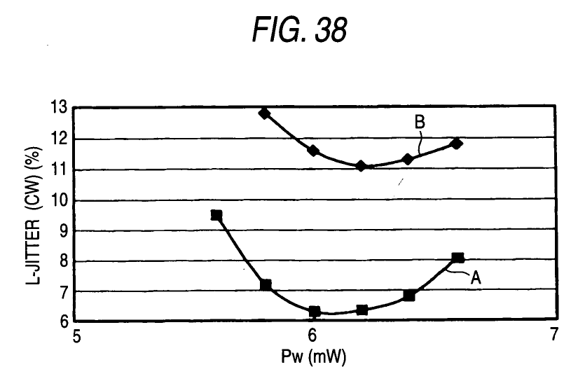

FIG. 38 is a graph showing a relationship between a jitter of a regenerative signal and a recording power Pw of a laser beam used for recording data according to the example 6 and a comparative example 6,

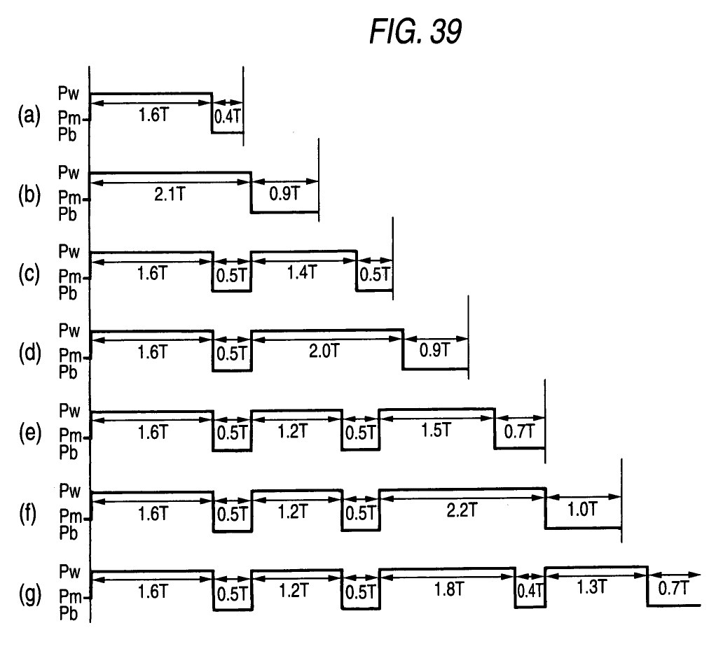

FIG. 39 is a diagram showing a recording strategy used for modulating the power of the laser beam according to the comparative example 6, and

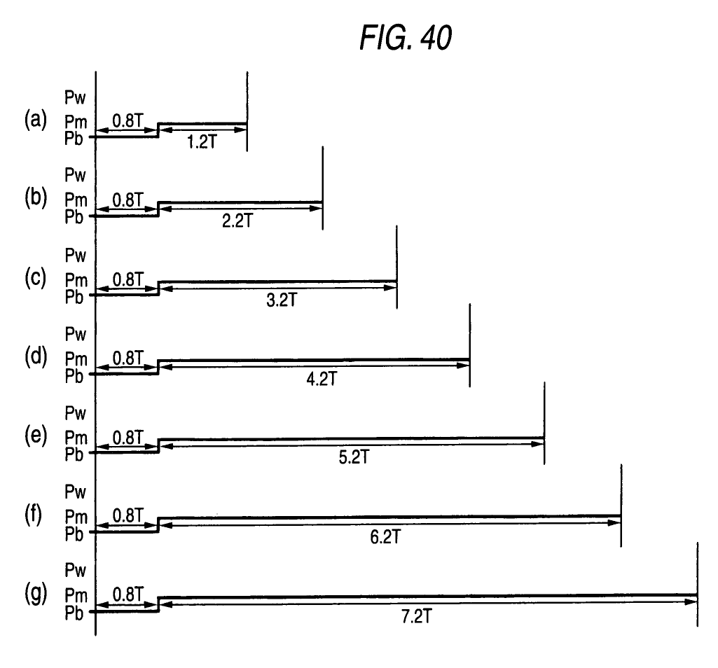

FIG. 40 is a diagram showing a recording strategy used for modulating the power of the laser beam according to the comparative example 6.

### DETAILED DESCRIPTION OF THE PREFERRED EMBODIMENTS

Preferred embodiments of the invention will be described below in detail with reference to the accompanying drawings.

FIG. 1 is a schematic sectional view showing an optical recording medium for recording data by a method of recording data according to a preferred embodiment of the invention.

As shown in FIG. 1, an optical recording medium 10 is constituted as a write-once optical recording medium, and comprises a disk-shaped support substrate 11, a transparent intermediate layer 12, a light transmitting layer 13, an L0 layer 20 provided between the support substrate 11 and the transparent intermediate layer 12, and an L1 layer 30 provided between the transparent intermediate layer 12 and the light transmitting layer 13.

The L0 layer 20 and the L1 layer 30 are recording layers for recording data, and the optical recording medium 10 according to the embodiment has two recording layers.

The L0 layer 20 constitutes a recording layer which is distant from the light transmitting layer 13 and is formed by laminating a reflecting film 21, a fourth dielectric film 22, an L0 recording layer 23 and a third dielectric film 24 from the support substrate 11 side.

On the other hand, the L1 layer 30 constitutes a recording layer which is close to the light transmitting layer 13, and is formed by laminating a second dielectric film 32, an L1 recording layer 33 and a first dielectric film 34 from the support substrate 11 side.

The support substrate 11 functions as a support for maintaining a mechanical strength required for the optical recording medium 10.

A material for forming the support substrate 11 is not particularly restricted if it can function as a support for the optical recording medium 10. The support substrate 11 can be formed of glass, ceramics or a resin, for example. In respect of the easiness of molding, the resin is preferably used. Examples of the resin include a polycarbonate resin, an acrylic resin, an epoxy resin, a polystyrene resin, a polyethylene resin, a polypropylene resin, a silicone resin, a fluorine type resin, an ABS resin, and a urethane resin. In respect of a workability and an optical characteristic, the polycarbonate resin is particularly preferable. In the embodiment, the support substrate 11 is formed by the polycarbonate resin. In the embodiment, a laser beam is irradiated through a light incidence plane 13a positioned on the opposite side of the support substrate 11. For this reason, the support substrate 11 does not need to have a light permeability.

In the embodiment, the support substrate 11 has a thickness of approximately 1.1 mm.

As shown in FIG. 1, a groove 11a and a land 11b are alternately formed on the surface of the support substrate 11. The groove 11a and/or the land 11b which are/is formed on the surface of the support substrate 11 function(s) as a guide track for a laser beam in the case in which data are to be recorded on the L0 layer 20 and the case in which the data are to be reproduced from the L0 layer 20.

The depth of the groove 11a is not particularly restricted but is preferably set to be 10 nm to 40 nm. The pitch of the groove 11a is not particularly restricted but is preferably set to be 0.2 μm to 0.4 μm.

The transparent intermediate layer 12 has the function of separating the L0 layer 20 from the L1 layer 30 at a physically and optically sufficient distance.

As shown in FIG. 1, a groove 12a and a land 12b are alternately provided on the surface of the transparent intermediate layer 12. The groove 12a and/or the land 12b which are/is formed on the surface of the transparent intermediate layer 12 function(s) as a guide track for a laser beam in the case in which data are to be recorded on the L1 layer 30 and the case in which the data are to be reproduced from the L1 layer 30.

The depth and pitch of the groove 12a can be set to be almost equal to that of the groove 11a provided on the surface of the support substrate 11.

The transparent intermediate layer 12 is preferably formed to have a thickness of 5 μm to 50 μm and is more preferably formed to have a thickness of 10 ml to 40 μm.

Although a material for forming the transparent intermediate layer 12 is not particularly restricted, it is preferable that an ultraviolet curing acrylic resin should be used.

The transparent intermediate layer 12 is required to have a sufficiently high light permeability in order to cause a laser beam to be transmitted therethrough in the case in which data are to be recorded on the L0 layer 20 and are to be reproduced from the L0 layer 20.

The light transmitting layer 13 is a layer for causing the laser beam to be transmitted therethrough and the light incidence plane 13a is constituted by one of surfaces thereof.

It is preferable that the light transmitting layer 13 should be formed to have a thickness of 30 μm to 200 μm.

Although a material for forming the light transmitting layer 13 is not particularly restricted, it is preferable that an ultraviolet curing acrylic resin should be used in the same manner as in the transparent intermediate layer 12.

The light transmitting layer 13 is required to have a sufficiently high light permeability in order to cause a laser beam to be transmitted therethrough in the case in which data are to be recorded on the L0 layer 20 or the L1 layer 30 and are to be reproduced from the L0 layer 20 or the L1 layer 30.

FIG. 2 is a schematic partial enlarged sectional view showing the L0 layer 20 in the optical recording medium 10 illustrated in FIG. 1.

As shown in FIG. 2, the L0 recording layer 23 includes a first L0 recording film 23a and a second L0 recording film 23b.

In the embodiment, the first L0 recording film 23a contains Si as a principal component and the second L0 recording film 23b contains Cu as a principal component.

In order to reduce the noise level of a regenerative signal and to enhance a storage reliability, it is preferable that at least one element selected from the group consisting of Al, Zn, Sn, Mg and Au should be added to the second L0 recording film 23b.

FIG. 3 is a schematic partial enlarged sectional view showing the first L1 layer 30 in the optical recording medium 10 illustrated in FIG. 1.

As shown in FIG. 3, the L1 recording layer 33 includes a first L1 recording film 33a and a second L1 recording film 33b.

In the embodiment, the first L1 recording film 33a contains Si as a principal component and the second L1 recording film 33b contains Cu as a principal component.

In order to reduce the noise level of a regenerative signal and to enhance a storage reliability, it is preferable that at least one element selected from the group consisting of Al, Zn, Sn, Mg and Au should be added to the second L1 recording film 33b.

In the case in which data are to be recorded on the L0 layer 20 and the data recorded on the L0 layer 20 are to be reproduced, a laser beam is irradiated through the L1 layer 30 positioned on a close side to the light transmitting layer 13.

Accordingly, the L1 layer 30 is required to have a high light permeability, and more specifically, the L1 layer 30 needs to have a light transmittance of 30% or more with respect to the wavelength of a laser beam to be used for recording and reproducing data and preferably has a light transmittance of 40% or more.

It is preferable that the L1 recording layer 33 should be formed to have a smaller thickness than the thickness of the L0 recording layer 23 in order to have a high light permeability. More specifically, the L0 recording layer 23 is preferably formed to have a thickness of 2 nm to 40 nm and the L1 recording layer 33 is preferably formed to have a thickness of 2 nm to 15 nm.

In the case in which the thicknesses of the L0 recording layer 23 and the L1 recording layer 33 are smaller than 2 nm, a change in a reflectance obtained before and after the irradiation of a laser beam is reduced so that a reproducing signal (C/N ratio) having a high intensity cannot be obtained.

On the other hand, when the thickness of the L1 recording layer 33 exceeds 15 nm, the light transmittance of the L1 layer 30 is reduced so that the recording characteristic of data on the L0 recording layer 23 and the reproducing characteristic of the data from the L0 recording layer 23 are deteriorated.

When the thickness of the L0 recording layer 23 exceeds 40 nm, moreover, a recording sensitivity is deteriorated.

In order to sufficiently increase the change in the reflectance obtained before and after the irradiation of the laser beam, furthermore, it is preferable that the first L1 recording film 33a, the second L1 recording film 33b, the first L0 recording film 23a and the second L0 recording film 23b should be formed in such a manner that the ratio of the thicknesses of the first L1 recording film 33a and the second L1 recording film 33b included in the L1 recording layer 33 (the thickness of the first L1 recording film 33a/the thickness of the second L1 recording film 33b) and the ratio of the thicknesses of the first L0 recording film 23a and the second L0 recording film 23b included in the L0 recording layer 23 (the thickness of the first L0 recording film 23a/the thickness of the second L0 recording film 23b) are 0.2 to 5.0.

The first dielectric film 34 and the second dielectric film 32 function as protective films for protecting the L1 recording layer 33, and the third dielectric film 24 and the fourth dielectric film 22 function as protective films for protecting the L0 recording layer 23.

The thicknesses of the first dielectric film 34, the second dielectric film 32, the third dielectric film 24 and the fourth dielectric film 22 are not particularly restricted but preferably have a thickness of 10 nm to 200 nm. In the case in which the thicknesses of these dielectric films are smaller than 10 nm, the function of the protective films is not sufficient. On the other hand, in the case in which the thicknesses of these dielectric films are greater than 200 nm, a time required for forming the films is prolonged. Consequently, there is a possibility that a productivity might be reduced or a crack might be generated on the L0 recording layer 23 or the L1 recording layer 33 by an internal stress.

The first dielectric film 34, the second dielectric film 32, the third dielectric film 24 and the fourth dielectric film 22 may have a single layer structure formed by one dielectric film or a lamination structure formed by two dielectric films or more. For example, it is possible to obtain a greater light interference effect by employing a lamination structure in which the first dielectric film 24 is constituted by two dielectric films having different refractive indices.

Materials for forming the first dielectric film 34, the second dielectric film 32, the third dielectric film 24 and the fourth dielectric film 22 are not particularly restricted but it is preferable that the first dielectric film 34, the second dielectric film 32, the third dielectric film 24 and the fourth dielectric film 22 should be formed by using oxides, nitrides, sulfides or carbides of Al, Si, Ce, Zn, Ta or Ti, for example, Al₂O₃, AlN, SiO₂, Si₃N₄, CeO₂, ZnS or TaO, or their mixtures, and particularly, it is more preferable that a dielectric constituted by ZnS.SiO₂ or TiO₂ should be contained as a principal component. Herein, “ZnS.SiO₂” implies a mixture of ZnS and SiO₂.

The reflecting film 21 included in the L0 layer 20 reflects a laser beam incident from the light incidence plane 13a and functions to emit the laser beam from the light incidence plane 13a again, and furthermore, to effectively radiate a heat generated on the L0 recording layer 23 by the irradiation of the laser beam.

It is preferable that the reflecting film 21 included in the L0 layer 20 should be formed to have a thickness of 20 nm to 200 nm. If the thickness of the reflecting film 21 included in the L0 layer 20 is smaller than 20 nm, it is hard to radiate a heat generated on the L0 recording layer 23. On the other hand, if the thickness of the reflecting film 21 is greater than 200 nm, a long time is required for forming the reflecting film 21. For this reason, there is a possibility that a productivity might be deteriorated and a crack might be generated by an internal stress.

A material for forming the reflecting film 21 included in the L0 layer 20 is not particularly restricted if it can reflect a laser beam, and the reflecting film 21 can be formed by Mg, Al, Ti, Cr, Fe, Co, Ni, Cu, Zn, Ge, Ag, Pt or Au. A metallic material such as Al, Au, Ag or Cu which has a high reflectance, or an alloy containing at least one of these metals, for example, an alloy of Ag and Cu is preferably used for forming the reflecting film 21.

The optical recording medium 10 having the above structure is manufactured in the following manner, for example.

FIGS. 4 to 7 are views showing steps in a method of manufacturing the optical recording medium 10.

As shown in FIG. 4, first of all, the support substrate 11 having the groove 11a and the land 11b is formed on a surface by using a stamper 40 through injection molding.

Next, the reflecting film 21 is formed by chemical vapor deposition using chemical species containing the constitutional element of the reflecting film 21 over almost the whole surface of the support substrate 11 having the groove 11a and the land 11b formed thereon. For the chemical vapor deposition, it is possible to use vacuum deposition or sputtering.

Furthermore, the fourth dielectric film 22 is formed on the reflecting film 21 by the chemical vapor deposition using chemical species containing the constitutional element of the fourth dielectric film 22. For the chemical vapor deposition, it is possible to use the vacuum deposition or the sputtering.

Subsequently, the second L0 recording film 23b is formed on the fourth dielectric film 22 by the chemical vapor deposition using chemical species containing the constitutional element of the second L0 recording film 23b, and the first L0 recording film 23a is formed on the second L0 recording film 23b by the chemical vapor deposition using chemical species containing the constitutional element of the first L0 recording film 23a so that the L0 recording layer 23 is formed. For the chemical vapor deposition, it is possible to use the vacuum deposition or the sputtering.

As shown in FIG. 5, furthermore, the third dielectric film 24 is formed on the first L0 recording film 23a by the chemical vapor deposition using chemical species containing the constitutional element of the third dielectric film 24 so that the L0 layer 20 is formed. For the chemical vapor deposition, it is possible to use the vacuum deposition or the sputtering.

As shown in FIG. 6, next, an ultraviolet curing resin is applied onto the L0 layer 20 by spin coating so that a coated film is formed, and ultraviolet rays are irradiated on the surface of the coated film through a stamper 41 in a state in which the surface is covered with the stamper 41 so that the transparent intermediate layer 12 provided with the groove 12a and the land 12b is formed on the surface.

Furthermore, the second dielectric film 32 is formed on almost the whole surface of the transparent intermediate layer 12 provided with the groove 12a and the land 12b by the chemical vapor deposition using chemical species containing the constitutional element of the second dielectric film 32 so that the second dielectric film 32 is formed. For the chemical vapor deposition, it is possible to use the vacuum deposition or the sputtering.

Subsequently, the second L1 recording film 33b is formed on the second dielectric film 32 by the chemical vapor deposition using chemical species containing the constitutional element of the second L1 recording film 33b, and the first L1 recording film 33a is formed on the second L1 recording film 33b by the chemical vapor deposition using chemical species containing the constitutional element of the first L1 recording film 33a so that the L1 recording layer 33 is formed. For the chemical vapor deposition, it is possible to use the vacuum deposition or the sputtering.

As shown in FIG. 7, moreover, the first dielectric film 34 is formed on the L1 recording layer 33 by the chemical vapor deposition using chemical species containing the constitutional element of the first dielectric film 34 so that the L1 layer 30 is formed. For the chemical vapor deposition, it is possible to use the vacuum deposition or the sputtering.

Next, an ultraviolet curing resin is applied onto the L1 layer 30 by the spin coating so that a coated film is formed, and ultraviolet rays are irradiated on the coated film so that the coated film is cured and the light transmitting layer 13 is thus formed.

Consequently, the optical recording medium 10 is fabricated.

In order to record data on the optical recording medium 10 constituted as described above, a laser beam having a power modulated is irradiated on the light incidence plane 13a of the light transmitting layer 13 and the laser beam is focused on the L0 recording layer 23 included in the L0 layer 20 or the L1 recording layer 33 included in the L1 layer 30.

Preferably, a laser beam having a wavelength of 350 nm to 450 nm is used for recording/reproducing data on/from the optical recording medium 10. In the embodiment, there is employed a structure in which a laser beam having a wavelength of 405 nm is collected onto the L0 recording layer 23 or the L1 recording layer 33 through the light transmitting layer 13 by an objective lens having a numerical aperture of 0.85.

As a result, in a region on which the laser beam is irradiated, Si and Cu contained as principal components in the first L0 recording film 23a and the second L0 recording film 23b of the L0 recording layer 23 respectively are mixed so that a recording mark M is formed as shown in FIG. 8 or Si and Cu contained as principal components in the first L1 recording film 33a and the second L1 recording film 33b of the L1 recording layer 30 respectively are mixed so that a recording mark M is formed as shown in FIG. 9.

Thus, the recording mark M is formed on the L0 recording layer 23 of the L0 layer 20 or the L1 recording layer 33 of the L1 layer 30 so that data are recorded.

FIGS. 10 and 11 are diagrams showing a method of modulating a laser beam power which has conventionally been used in the case in which data are to be recorded on an optical recording medium at a high recording linear speed by using a (1, 7) RLL modulating method, that is, a conventional recording strategy, and FIGS. 10(a), (b), (c), (d), (e), (f) and (g) show the modulating pattern of a laser beam power in the case in which recording marks M having lengths corresponding to a 2T signal to an 8T signal are to be formed respectively, and FIGS. 11(a), (b), (c), (d), (e), (f) and (g) show the modulating pattern of a laser beam power in the case in which blank regions corresponding to the 2T signal to the 8T signal are to be formed respectively.

As shown in FIGS. 10 and 11, in the conventional recording strategy, the power of the laser beam is modulated by using a single pulse when forming a recording mark having a length corresponding to a 2T signal and when forming a recording mark having a length corresponding to a 3T signal, using two pulses when forming a recording mark having a length corresponding to a 4T signal and when forming a recording mark having a length corresponding to a 5T signal, using three pulses when forming a recording mark having a length corresponding to a 6T signal and when forming a recording mark having a length corresponding to a 7T signal, and using four pulses when forming a recording mark having a length corresponding to an 8T signal, respectively.

As shown in FIGS. 10 and 11, the power of the laser beam is constituted to be modulated into three levels having a recording power Pw, a base power Pb and an intermediate power Pm having a level which is higher than the base power Pb and is lower than the recording power Pw. The recording strategy is determined in such a manner that the power of the laser beam is set to be the recording power Pw at the top of the pulse and is set to be the base power Pb at the bottom of the pulse also in the case in which the recording mark M having the length corresponding to the 2T signal or the 8T signal is to be formed. On the other hand, the recording strategy is determined in such a manner that the power of the laser beam is set to be the base power Pb at first and is then set to be the intermediate power Pm also in the case in which blank regions having the lengths corresponding to the 2T signal to the 8T signal are to be formed.

According to the recording strategy, in the case in which the recording marks M having the lengths corresponding to the 3T signal to the 8T signal are to be formed, the number of pulses to be used for modulating the power of the laser beam is more decreased as compared with an (n−1) recording strategy which is usually used. Also in the case in which the data are to be recorded at a high recording linear speed, therefore, it is possible to modulate the power of the laser beam as desired.

In the case in which the power of the laser beam is modulated to record the data on the L1 recording layer 33 or the L0 recording layer 23 in the optical recording medium 10 in accordance with the recording strategy, however, there is a problem in that it is very hard to form a recording mark having a desirable length on the L1 recording layer 33 or the L0 recording layer 23 when forming the recording mark M having the length corresponding to the 3T signal.

More specifically, as shown in FIGS. 10(a) and 10(b), in the case in which the recording mark M having the length corresponding to the 3T signal is to be formed, a single pulse is used to modulate the power of the laser beam in the same manner as in the case in which the recording mark M having the length corresponding to the 2T signal is to be formed. As compared with the case in which the recording mark M having the length corresponding to the 2T signal is to be formed, therefore, a period for which the power of the laser beam is set to be the recording power Pw is necessarily prolonged more greatly. Accordingly, the front part of the recording mark M is influenced by a heat generated from the recording mark M formed on the L1 recording layer 33 or the L0 recording layer 23 immediately before so that the recording mark M is extended forward. As a result, there is a problem in that the length of the recording mark M is greater than a desirable length and the jitter of a regenerative signal is thus deteriorated.

In particular, the laser beam is transmitted through the L1 layer 30 when the data are to be recorded on the L0 recording layer 23 and the data recorded on the L0 recording layer 23 are to be reproduced. Therefore, a reflecting film is not provided. For this reason, in the case in which the recording mark M having the length corresponding to the 3T signal is to be formed on the L0 recording layer 23, it is impossible to form a recording mark having a desirable length.

More specifically, the L0 layer 20 includes the reflecting film 21. When a laser beam is irradiated on a region of the L0 recording layer 23 on which the recording mark M is to be formed in order to form the recording mark M on the L0 recording layer 23, a heat generated by the laser beam thus irradiated can be quickly transmitted to the other regions of the L0 recording layer 23 through the reflecting film 21. Accordingly, the front part of the recording mark M is not influenced by a large heat generated from the recording mark M formed on the L0 recording layer 23 immediately before. However, the L1 layer 30 does not include a reflecting film. When the laser beam is irradiated on a region of the L1 recording layer 33 on which the recording mark M is to be formed in order to form the recording mark M on the L1 recording layer 33 included in the L1 layer 30, therefore, the heat generated by the laser beam thus irradiated cannot be transmitted to the other regions of the L1 recording layer 33 through the reflecting film. Accordingly, the heat generated by the laser beam is easily stored in the region of the L1 recording layer 33 on which the recording mark M is formed. Therefore, the front part of the recording mark M is easily influenced by a large heat generated from the recording mark M formed on the L1 recording layer 33 immediately before. Thus, there is a problem in that the length of the recording mark M is increased and the jitter of a regenerative signal is thus deteriorated.

FIGS. 12 and 13 are diagrams showing a method of modulating the power of a laser beam when recording data on the L1 recording layer 33 or the L0 recording layer 23 in the optical recording medium 10 by using a (1, 7) RLL modulating system, that is, a recording strategy in a method of recording data according to a preferred embodiment of the invention.

FIGS. 12(a), (b), (c), (d), (e), (f) and (g) show the modulating pattern of a laser beam in the case in which recording marks M having lengths corresponding to a 2T signal to an 8T signal are to be formed respectively, and FIGS. 13(a), (b), (c), (d), (e), (f) and (g) show the modulating pattern of a laser beam power in the case in which blank regions having the lengths corresponding to the 2T signal to the 8T signal are to be formed respectively.

Also in the recording strategy according to the embodiment, in the case in which the blank regions having the lengths corresponding to the 2T signal to the 8T signal are to be formed on the L1 recording layer 33 or the L0 recording layer 23 in the optical recording medium 10 as shown in FIG. 13, the power of the laser beam is modulated in the same manner as in FIG. 11. In the case in which the recording marks M having the lengths corresponding to the 2T signal to the 8T signal are to be formed as shown in FIG. 12, moreover, the number of pulses to be used for modulating the power of the laser beam is also the same as that in FIG. 11. In the embodiment, however, the power of the laser beam is modulated in such a manner that a timing for causing the power of the laser beam to rise to be the recording power Pw is delayed by 0.2T from that in the case in which the recording mark M having the length corresponding to the 2T signal is to be formed when the recording mark M having the length corresponding to the 3T signal is to be formed as shown in FIG. 10(b). According to the studies of the inventor, the following has been found. In the case in which the recording mark M having the length corresponding to the 3T signal is to be formed, thus, the timing for causing the power of the laser beam to rise to be the recording power Pw is delayed by 0.2T as compared with the case in which the recording mark M having the length corresponding to the 2T signal is to be formed. Also in the case in which the recording mark M having the length corresponding to the 3T signal is to be formed on the L1 recording layer 33 of the optical recording medium 10, consequently, the recording mark M having a desirable length can be formed.

According to the embodiment, therefore, in the case in which the recording mark M having the length corresponding to the 3T signal is to be formed on the L0 recording layer 23 or the L1 recording layer 33 in the optical recording medium 10, the recording mark M having the desirable length can be formed. Consequently, the jitter of a regenerative signal can be reduced considerably.

FIGS. 14 and 15 are diagrams showing a method of modulating the power of a laser beam when recording data on the L1 recording layer 33 or the L0 recording layer 23 in the optical recording medium 10 by using a (1, 7) RLL modulating system, that is, a recording strategy in a method of recording data according to another preferred embodiment of the invention.

FIGS. 14(a), (b), (c), (d), (e), (f) and (g) show the modulating pattern of a laser beam in the case in which recording marks M having lengths corresponding to a 2T signal to an 8T signal are to be formed respectively, and FIGS. 15(a), (b), (c), (d), (e), (f) and (g) show the modulating pattern of a laser beam power in the case in which blank regions having the lengths corresponding to the 2T signal to the 8T signal are to be formed respectively.

The recording strategy according to the embodiment is preferably employed in the case in which data are to be recorded at a higher recording linear speed than that in the recording strategy shown in FIGS. 12 and 13.

Also in the recording strategy according to the embodiment, in the case in which the blank regions having the lengths corresponding to the 2T signal to the 8T signal are to be formed on the L1 recording layer 33 or the L0 recording layer 23 in the optical recording medium 10 as shown in FIG. 15, the power of the laser beam is modulated in the same manner as in FIG. 11. In the case in which the recording mark M having the length corresponding to the 3T signal is to be formed as shown in FIG. 14, moreover, the power of the laser beam is modulated in such a manner that the timing for causing the power of the laser beam to rise to be a recording power Pw is delayed by 0.2T as compared with the case in which the recording mark M having the length corresponding to the 2T signal is to be formed in the same manner as in FIG. 12. In the embodiment, as shown in FIG. 14(c), in the case in which the recording mark M having the length corresponding to the 4T signal is to be further formed, the power of the laser beam is modulated by using a single pulse in such a manner that the timing for causing the power of the laser beam to be the recording power Pw is delayed by 0.3T as compared with the case in which the recording mark M having the length corresponding to the 2T signal is to be formed.

According to the studies of the inventor, the following has been found. More specifically, in the case in which the recording mark M having the length corresponding to the 4T signal is to be formed, the length of the recording mark M tends to be greater than a desirable length so that a deterioration in the jitter of a regenerative signal is recognized when the power of the laser beam is modulated by using the single pulse. Even if the power of the laser beam is modulated by using the single pulse when the recording mark M having the length corresponding to the 4T signal is to be formed, the recording mark M having a desirable length can be formed also when the recording mark M having the length corresponding to the 4T signal is formed on the L1 recording layer 33 in the case in which the power of the laser beam is modulated in such a manner that the timing for causing the power of the laser beam to rise to be the recording power Pw is delayed by 0.3T as compared with the case in which the recording mark M having the length corresponding to the 2T signal is to be formed. Consequently, the jitter of the regenerative signal can be reduced considerably. According to the embodiment, therefore, also in the case in which the recording mark M having the length corresponding to the 4T signal is to be formed on the L0 recording layer 23 or the L1 recording layer 33 in the optical recording medium 10 to record data, the recording mark M having the desirable length can be formed and the jitter of a regenerative signal can be thus reduced considerably.

FIGS. 16 and 17 are diagrams showing a method of modulating the power of a laser beam when recording data on the L1 recording layer 33 or the L0 recording layer 23 in the optical recording medium 10 by using a (1, 7) RLL modulating system, that is, a recording strategy in a method of recording data according to a further preferred embodiment of the invention.

FIGS. 16(a), (b), (c), (d), (e), (f) and (g) show the modulating pattern of a laser beam in the case in which recording marks M having lengths corresponding to a 2T signal to an 8T signal are to be formed respectively, and FIGS. 17(a), (b), (c), (d), (e), (f) and (g) show the modulating pattern of a laser beam power in the case in which blank regions having the lengths corresponding to the 2T signal to the 8T signal are to be formed respectively.

Also in the recording strategy according to the embodiment, in the case in which the blank regions having the lengths corresponding to the 2T signal to the 8T signal are to be formed on the L1 recording layer 33 or the L0 recording layer 23 in the optical recording medium 10 as shown in FIG. 17, the power of the laser beam is modulated in the same manner as in FIG. 11. In the case in which the recording mark M having the length corresponding to the 3T signal is to be formed as shown in FIG. 16, moreover, the power of the laser bream is modulated in such a manner that the timing for causing the power of the laser beam to rise to be the recording power Pw is delayed by 0.2T as compared with the case in which the recording mark M having the length corresponding to the 2T signal is to be formed in the same manner as in FIG. 14. In the case in which the recording mark M having the length corresponding to the 4T signal is to be formed, the power of the laser beam is modulated by using a single pulse in such a manner that the timing for causing the power of the laser beam to rise to be the recording power Pw is delayed by 0.3T as compared with the case in which the recording mark M having the length corresponding to the 2T signal is to be formed in the same manner as in FIG. 14. In the embodiment, as shown in FIG. 16(d), in the case in which the recording mark M having the length corresponding to the 5T signal is to be further formed, the power of the laser beam is modulated by using a single pulse in such a manner that the timing for causing the power of the laser beam to rise to be the recording power Pw is delayed by 0.3T as compared with the case in which the recording mark M having the length corresponding to the 2T signal is to be formed.

According to the studies of the inventor, the following has been found. More specifically, in the case in which the recording mark M having the length corresponding to the 5T signal is to be formed, the length of the recording mark M tends to be greater than a desirable length so that a deterioration in the jitter of a regenerative signal is recognized when the power of the laser beam is modulated by using the single pulse. Even if the power of the laser beam is modulated by using the single pulse when the recording mark M having the length corresponding to the 5T signal is to be formed, the recording mark M having a desirable length can be formed also when the recording mark M having the length corresponding to the 5T signal is formed on the L1 recording layer 33 in the case in which the power of the laser beam is modulated in such a manner that the timing for causing the power of the laser beam to rise to be the recording power Pw is delayed by 0.3T as compared with the case in which the recording mark M having the length corresponding to the 2T signal is to be formed. Consequently, the jitter of the regenerative signal can be reduced considerably. According to the embodiment, therefore, also in the case in which the recording mark M having the length corresponding to the 5T signal is to be formed on the L0 recording layer 23 or the L1 recording layer 33 in the optical recording medium 10 to record data, the recording mark M having the desirable length can be formed and the jitter of a regenerative signal can be thus reduced considerably.

FIGS. 18 and 19 are diagrams showing a method of modulating the power of a laser beam when recording data on the L1 recording layer 33 or the L0 recording layer 23 in the optical recording medium 10 by using a (1, 7) RLL modulating system, that is, a recording strategy in a method of recording data according to a further preferred embodiment of the invention.

FIGS. 18(a), (b), (c), (d), (e), (f) and (g) show the modulating pattern of a laser beam in the case in which recording marks M having lengths corresponding to a 2T signal to an 8T signal are to be formed respectively, and FIGS. 19(a), (b), (c), (d), (e), (f) and (g) show the modulating pattern of a laser beam power in the case in which blank regions having the lengths corresponding to the 2T signal to the 8T signal are to be formed respectively.

Also in the recording strategy according to the embodiment, in the case in which the blank regions having the lengths corresponding to the 2T signal to the 8T signal are to be formed on the L1 recording layer 33 or the L0 recording layer 23 in the optical recording medium 10 as shown in FIG. 19, the power of the laser beam is modulated in the same manner as in FIG. 11. In the case in which the recording marks M having the lengths corresponding to the 3T signal to the 5T signal are to be formed as shown in FIG. 18, moreover, the power of the laser beam is modulated by using a single pulse and the timing for causing the power of the laser beam to rise to be the recording power Pw is delayed as compared with the case in which the recording mark M having the length corresponding to the 2T signal is to be formed in the same manner as in FIG. 16. In the embodiment, as shown in FIG. 18(e), in the case in which the recording mark M having the length corresponding to the 6T signal is to be further formed, the power of the laser beam is modulated by using a single pulse in such a manner that the timing for causing the power of the laser beam to rise to be the recording power Pw is delayed by 0.4T as compared with the case in which the recording mark M having the length corresponding to the 2T signal is to be formed.

According to the studies of the inventor, the following has been found. More specifically, in the case in which the recording mark M having the length corresponding to the 6T signal is to be formed, the length of the recording mark M tends to be greater than a desirable length so that a deterioration in the jitter of a regenerative signal is recognized when the power of the laser beam is modulated by using the single pulse. Even if the power of the laser beam is modulated by using the single pulse when the recording mark M having the length corresponding to the 6T signal is to be formed, the recording mark M having a desirable length can be formed also when the recording mark M having the length corresponding to the 6T signal is formed on the L1 recording layer 33 in the case in which the power of the laser beam is modulated in such a manner that the timing for causing the power of the laser beam to rise to be the recording power Pw is delayed by 0.4T as compared with the case in which the recording mark M having the length corresponding to the 2T signal is to be formed. Consequently, the jitter of the regenerative signal can be reduced considerably. According to the embodiment, therefore, also in the case in which the recording mark M having the length corresponding to the 6T signal is to be formed on the L0 recording layer 23 or the L1 recording layer 33 in the optical recording medium 10 to record data, the recording mark M having the desirable length can be formed and the jitter of the regenerative signal can be thus reduced considerably.

FIG. 20 is a block diagram showing a data recording apparatus according to a preferred embodiment of the invention.

As shown in FIG. 20, the data recording apparatus according to the embodiment comprises a control unit 50 for controlling the operation of the whole data recording apparatus, a head 51 including a laser beam source (not shown) for emitting a laser beam and an objective lens (not shown) having a numerical aperture of 0.85, laser beam control means 52, lens focus regulating means 53, tracking means 54 for regulating the position of the head 51 in such a manner that the laser beam emitted from the laser beam source follows the center of the track of the optical recording medium 10, and a memory 55.

When data are to be recorded on the optical recording medium 10, first of all, the optical recording medium 10 is set into the data recording apparatus.

When the optical recording medium 10 is set into the data recording apparatus, the control unit 50 first outputs a lens focus regulating signal to the lens focus regulating means 53 to regulate the position of the objective lens (not shown) in such a manner that a laser beam is focused on either the L0 recording layer 23 or the L1 recording layer 33 on which data are to be recorded.

Subsequently, the control unit 50 outputs a tracking execution signal to the tracking means 54, thereby regulating the position of the head 51.

In the embodiment, ID data for specifying the type of the optical recording medium 10 are recorded as a wobble or a prepit on the optical recording medium 10 on which data are to be recorded. Accordingly, the control unit 50 further reads the ID data recorded on the optical recording medium 10 and stores the same ID data in the memory 55.

Next, the control unit 50 builds a recording strategy based on the ID data read from the memory 55, and generates a laser beam power control signal in accordance with the recording strategy thus built and outputs the laser beam power control signal to the laser beam control means 52, irradiates a laser beam having a power modulated on the L0 recording layer 23 or the L1 recording layer 33 in the optical recording medium 10 through the light transmitting layer 13 in accordance with the recording strategy and records the data on the L0 recording layer 23 or the L1 recording layer 33 in the optical recording medium 10.

According to the embodiment, based on the ID data recorded on the optical recording medium 10, any of the recording strategy shown in FIGS. 12 and 13, the recording strategy shown in FIGS. 14 and 15, the recording strategy shown in FIGS. 16 and 17, and the recording strategy shown in FIGS. 18 and 19 which is the most proper corresponding to the type of the optical recording medium 10 and the recording linear speed is built by the control unit 50 of the data recording apparatus, for example. In accordance with the recording strategy thus built, the power of the laser beam is modulated so that the data are recorded on the L0 recording layer 23 or the L1 recording layer 33 in the optical recording medium 10. Based on the data thus recorded, consequently, it is possible to generate a regenerative signal in which a jitter is considerably reduced.

### EXAMPLES

In order to cause the advantage of the invention to be clearer, examples will be given below.

### Example 1

An optical recording medium sample #1 was fabricated in the following manner.

First of all, a disk-shaped polycarbonate substrate was fabricated by injection molding. The polycarbonate substrate had a thickness of 1.1 mm and a diameter of 120 mm, and had a groove and a land formed on a surface thereof in a track pitch (a groove pitch) of 0.32 μm.

Next, the polycarbonate substrate was set into a sputtering apparatus, and a reflecting film constituted by an alloy of Ag, Pd and Cu and having a thickness of 100 nm, a fourth dielectric film containing a mixture of ZnS and SiO₂ and having a thickness of 28 nm, a second L0 recording film containing Cu as a principal component and having a thickness of 5 nm, a first L0 recording film containing Si as a principal component and having a thickness of 5 nm, and a third dielectric film containing a mixture of ZnS and SiO₂ and having a thickness of 25 nm were sequentially formed by sputtering on the surface of the polycarbonate substrate on which the groove and the land were provided. Thus, an L0 layer was formed.

A mole ratio of ZnS to SiO₂ in the mixture of ZnS and SiO₂ contained in the third dielectric film and the fourth dielectric film was 80:20.

Furthermore, the polycarbonate substrate having the L0 layer formed on the surface thereof was set into a spin coating apparatus and an acrylic ultraviolet curing resin was dissolved in a solvent while the polycarbonate substrate was rotated. A resin solution thus prepared was applied onto the third dielectric film to form a coated film, and a stamper having a groove and a land formed thereon was put on the surface of the coated film and ultraviolet rays were irradiated on the coated film through the stamper, thereby curing the acrylic ultraviolet curing resin, and then, the stamper was peeled. Thus, a transparent intermediate layer having a surface provided with a groove and a land in a track pitch (a groove pitch) of 0.32 μm and having a thickness of 25 μm was formed.

Subsequently, the polycarbonate substrate having the surface provided with the L0 layer and the transparent intermediate layer was set into the sputtering apparatus, and a second dielectric film containing a mixture of ZnS and SiO₂ and having a thickness of 115 nm, a second L1 recording film containing Cu as a principal component and having a thickness of 5 nm, a first L1 recording film containing Si as a principal component and having a thickness of 4 nm, and a first dielectric film containing TiO₂ and having a thickness of 30 nm were sequentially formed by the sputtering on the surface of the transparent intermediate layer provided on the L0 layer. Thus, an L1 layer was formed on the surface of the transparent intermediate layer.

A mole ratio of ZnS to SiO₂ in the mixture of ZnS and SiO₂ contained in the second dielectric film was 80:20.

Furthermore, an acrylic ultraviolet curing resin was dissolved in a solvent and a resin solution thus prepared was applied onto the first dielectric film by spin coating to form a coated film, and ultraviolet rays were irradiated on the coated film to cure the acrylic ultraviolet curing resin so that a light transmitting layer having a thickness of 75 μm was formed. Thus, the optical recording medium sample #1 was fabricated.

The optical recording medium sample #1 thus obtained was set into an optical recording medium evaluating apparatus “DDU1000” (trade name) manufactured by Pulstec Industrial Co., Ltd. and a blue laser beam having a wavelength of 405 nm was used as a recording laser beam, and the laser beam was collected onto a first L1 recording film and a second L1 recording film through a light transmitting layer by using an objective lens having an NA (numerical aperture) of 0.85 and the power of the laser beam was modulated in accordance with the recording strategy shown in FIGS. 12 and 13, and data were thus recorded on the following recording conditions.

Modulating system: (1, 7) RLL

Channel bit length: 0.112 μm

Recording linear speed: 19.7 m/second

Channel clock: 264 MHz

Recording signal: random signal including 2T signal to 8T signal

In the laser beam, a recording power Pw was set to be 9.2 mW, a base power Pb was set to be 1.8 mW, and an intermediate power Pm was set to be 5.5 mW.

Subsequently, the random signal including the 2T signal to the 8T signal recorded on the first L1 recording film and the second L1 recording film in the optical recording medium sample #1 was regenerated by using the optical recording medium evaluating apparatus and the jitter of the regenerative signal was thus measured. In order to reproduce data, the wavelength of the laser beam was set to be 405 nm, the NA (numerical aperture) of an objective lens was set to be 0.85, and the power of the laser beam was set to be 0.7 mW.

Similarly, the recording power Pw of the laser beam was increased to 11.4 mW every 0.2 mW, and the random signal including the 2T signal to the 8T signal was recorded on the first L1 recording film and the second L1 recording film and the random signal including the 2T signal to the 8T signal which were recorded was regenerated to measure the jitter of the regenerative signal.

The result of the measurement is shown in a curve A of FIG. 21.

### Comparative Example 1

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 1 except that the power of a laser beam was modulated and the recording power Pw of the laser beam was changed every 0.2 mW within a range of 9.4 mW to 11.0 mW in accordance with the recording strategy shown in FIGS. 10 and 11.

The result of the measurement is shown in a curve B of FIG. 21.

As shown in FIG. 21, the following was recognized. More specifically, in the case in which the power of the laser beam is modulated to form a recording mark in such a manner that a timing for causing the power of the laser beam to rise to be the recording power Pw when modulating the power of the laser beam by using a single pulse to form a recording mark having a length corresponding to the 3T signal on the first L1 recording film and the second L1 recording film in the optical recording medium sample #1 is delayed by 0.2T from a timing for forming a recording mark having a length corresponding to the 2T signal, the jitter of a regenerative signal obtained by reproducing data can be reduced more considerably as compared with the case in which the power of the laser beam is modulated to form a recording mark in such a manner that the power of the laser beam rises to be the recording power Pw in the same timing also when the recording marks having lengths corresponding to the 2T signal to the 8T signal are to be formed as shown in FIGS. 10 and 11.

### Example 2

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 1 except that the power of the laser beam was modulated in accordance with the recording strategy shown in FIGS. 14 and 15 and the recording power Pw of the laser beam was changed every 0.2 mW within a range of 9.2 mW to 11.2 mW.

The result of the measurement is shown in a curve A of FIG. 22.

### Comparative Example 2

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 1 except that the power of the laser beam was modulated in accordance with the recording strategy shown in FIGS. 23 and 24 and the recording power Pw of the laser beam was changed every 0.2 mW within a range of 9.4 mW to 11.2 mW.

The result of the measurement is shown in a curve B of FIG. 22.

As shown in FIG. 22, the following was recognized. More specifically, in the case in which the power of the laser beam is modulated to form a recording mark in such a manner that a timing for causing the power of the laser beam to rise to be the recording power Pw when modulating the power of the laser beam by using a single pulse to form a recording mark having the length corresponding to the 4T signal on the first L1 recording film and the second L1 recording film in the optical recording medium sample #1 is delayed by 0.3T from a timing for forming a recording mark having the length corresponding to the 2T signal, the jitter of a regenerative signal obtained by reproducing the recorded data can be reduced more considerably as compared with the case in which the power of the laser beam is modulated to form a recording mark in such a manner that the power of the laser beam rises to be the recording power Pw in the same timing for forming the recording marks having the lengths corresponding to the 2T signal and the 5T signal to the 8T signal when the recording mark having the length corresponding to the 4T signal is to be formed on the first L1 recording film and the second L1 recording film in the optical recording medium sample #1.

### Example 3

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 1 except that the power of the laser beam was modulated in accordance with the recording strategy shown in FIGS. 16 and 17 and the recording power Pw of the laser beam was changed every 0.2 mW within a range of 9.2 mW to 11.2 mW.

The result of the measurement is shown in a curve A of FIG. 25.

### Comparative Example 3

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 1 except that the power of the laser beam was modulated in accordance with the recording strategy shown in FIGS. 26 and 27 and the recording power Pw of the laser beam was changed every 0.2 mW within a range of 9.4 mW to 11.2 mW.

The result of the measurement is shown in a curve B of FIG. 25.

As shown in FIG. 25, the following was recognized. More specifically, in the case in which the power of the laser beam is modulated to form a recording mark in such a manner that a timing for causing the power of the laser beam to rise to be the recording power Pw when modulating the power of the laser beam by using a single pulse to form a recording mark having the lengths corresponding to the 5T signal on the first L1 recording film and the second L1 recording film in the optical recording medium sample #1 is delayed by 0.3T from a timing for forming the recording marks having the lengths corresponding to the 2T signal and the 6T signal to the 8T signal, the jitter of a regenerative signal obtained by reproducing the recorded data can be reduced more considerably as compared with the case in which the power of the laser beam is modulated to form a recording mark in such a manner that the power of the laser beam rises to be the recording power Pw in the same timing for forming the recording marks having the lengths corresponding to the 2T signal and the 6T signal to the 8T signal when the recording mark having the length corresponding to the 5T signal is to be formed on the first L1 recording film and the second L1 recording film in the optical recording medium sample #1.

### Example 4

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 1 except that the power of the laser beam was modulated in accordance with the recording strategy shown in FIGS. 18 and 19 and the recording power Pw of the laser beam was changed every 0.2 mW within a range of 9.4 mW to 11.2 mW.

The result of the measurement is shown in a curve A of FIG. 28.

### Comparative Example 4

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 1 except that the power of the laser beam was modulated in accordance with the recording strategy shown in FIGS. 29 and 30 and the recording power Pw of the laser beam was changed every 0.2 mW within a range of 9.6 mW to 10.8 mW

The result of the measurement is shown in a curve B of FIG. 28.

As shown in FIG. 28, the following was recognized. More specifically, in the case in which the power of the laser beam is modulated to form a recording mark in such a manner that a timing for causing the power of the laser beam to rise to be the recording power Pw when modulating the power of the laser beam to form the recording mark having the length corresponding to the 6T signal on the first L1 recording film and the second L1 recording film in the optical recording medium sample #1 is delayed by 0.4T from a timing for forming the recording marks having the lengths corresponding to the 2T signal, the 7T signal and the 8T signal, the jitter of a regenerative signal obtained by reproducing the recorded data can be reduced more considerably as compared with the case in which the power of the laser beam is modulated to form a recording mark in such a manner that the power of the laser beam rises to be the recording power Pw in the same timing for forming the recording marks having the lengths corresponding to the 2T signal, the 7T signal and 8T signal when the recording mark having the length corresponding to the 6T signal is to be formed on the first L1 recording film and the second L1 recording film in the optical recording medium sample #1.

### Example 5

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 1 except that the power of the laser beam was modulated in accordance with the recording strategy shown in FIGS. 31 and 32, the recording linear speed was set to be 9.8 m/second, the channel clock was set to be 132 MHz, and furthermore, the base power Pb was set to be 0.1 mW, the intermediate power Pm was set to be 3.3 mW, and the recording power Pw of the laser beam was changed every 0.2 mW within a range of 6.8 mW to 8.6 mW.

The result of the measurement is shown in a curve A of FIG. 33.

### Comparative Example 5

The random signal including the 2T signal to the 8T signal was recorded on the first L1 recording film and the second L1 recording film in the optical recording medium sample #1 and the random signal including the 2T signal to the 8T signal thus recorded was regenerated to measure the jitter of the regenerative signal in the same manner as in the example 5 except that the power of the laser beam was modulated in accordance with the recording strategy shown in FIGS. 34 and 35, the base power Pb was set to be 0.1 mW, the intermediate power Pm was set to be 3.3 mW, and the recording power Pw of the laser beam was changed every 0.2 mW within a range of 7.0 mW to 8.4 mW.

The result of the measurement is shown in a curve B of FIG. 33.

As shown in FIG. 33, the following was recognized. More specifically, in the case in which the recording linear speed is low and the power of the laser beam is modulated to form a recording mark in such a manner that a timing for causing the power of the laser beam to rise to be the recording power Pw when modulating the power of the laser beam by using a single pulse to form the recording mark having the length corresponding to the 3T signal on the first L1 recording film and the second L1 recording film in the optical recording medium sample #1 is delayed by 0.2T from a timing for forming the recording marks having the lengths corresponding to the 2T signal and the 4T signal to the 8T signal, the jitter of a regenerative signal obtained by reproducing the recorded data can be reduced more considerably as compared with the case in which the power of the laser beam is modulated to form a recording mark in such a manner that the power of the laser beam rises to be the recording power Pw in the same timing for forming the recording marks having the lengths corresponding to the 2T signal to the 8T signal as shown in FIGS. 34 and 35.

Accordingly, the following was found. More specifically, also in the case in which the data are to be recorded on the L1 recording layer at a low recording linear speed in addition to the case in which the data are to be recorded on the L1 recording layer at a high recording linear speed, the power of the laser beam is modulated in such a manner that the timing for causing the power of the laser beam to rise to be the recording power Pw when modulating the power of the laser beam by using a single pulse to form the recording mark having the length corresponding to the 3T signal is delayed by 0.2T from the case in which the recording marks having the lengths corresponding to the 2T signal and the 4T signal to the 8T signal are to be formed. Thus, it is possible to considerably reduce the jitter of a regenerative signal obtained by reproducing the recorded data.

### Example 6

An optical recording medium sample #2 was fabricated in the following manner.

First of all, a disk-shaped polycarbonate substrate was fabricated by injection molding. The polycarbonate substrate had a thickness of 1.1 mm and a diameter of 120 mm, and had a groove and a land formed on a surface thereof in a track pitch (a groove pitch) of 0.32 μm.

Next, the polycarbonate substrate was set into a sputtering apparatus, and a reflecting film constituted by an alloy of Ag, Pd and Cu and having a thickness of 100 nm, a second dielectric film containing a mixture of ZnS and SiO₂ and having a thickness of 28 nm, a second recording film containing Cu as a principal component and having a thickness of 5 nm, a first recording film containing Si as a principal component and having a thickness of 5 nm, and a first dielectric film containing a mixture of ZnS and SiO₂ and having a thickness of 25 nm were sequentially formed by sputtering on the surface of the polycarbonate substrate on which the groove and the land were provided.

A mole ratio of ZnS to SiO₂ in the mixture of ZnS and SiO₂ contained in the first dielectric film and the second dielectric film was 80:20.

Furthermore, the polycarbonate substrate provided with the reflecting film, the second dielectric film, the second recording film, the first recording film and the first dielectric film was set into a spin coating apparatus, an acrylic ultraviolet curing resin was dissolved in a solvent and a resin solution thus prepared was applied onto the first dielectric film by spin coating to form a coated film, and ultraviolet rays were irradiated on the coated film to cure the acrylic ultraviolet curing resin so that a light transmitting layer having a thickness of 100 μm was formed. Thus, the optical recording medium sample #2 was fabricated.

The random signal including the 2T signal to the 8T signal was recorded on the first recording film and the second recording film in the optical recording medium sample #2 and the random signal including the 2T signal to the 8T signal thus recorded was regenerated to measure the jitter of the regenerative signal in the same manner as in the example 1 except that the optical recording medium sample #2 thus obtained was set into an optical recording medium evaluating apparatus “DDU1000” (trade name) manufactured by Pulstec Industrial Co., Ltd. and the power of the laser beam was modulated in accordance with the recording strategy shown in FIGS. 36 and 37, and furthermore, the base power Pb was set to be 1.0 mW, the intermediate power Pm was set to be 2.5 mW, and the recording power Pw of the laser beam was changed every 0.2 mW within a range of 5.6 mW to 6.6 mW.

The result of the measurement is shown in a curve A of FIG. 38.

### Comparative Example 6

The random signal including the 2T signal to the 8T signal was recorded on the first recording film and the second recording film in the optical recording medium sample #2 and the random signal including the 2T signal to the 8T signal thus recorded was regenerated to measure the jitter of the regenerative signal in the same manner as in the example 6 except that the power of the laser beam was modulated in accordance with the recording strategy shown in FIGS. 39 and 40, the base power Pb was set to be 1.0 mW, the intermediate power Pm was set to be 2.5 mW, and the recording power Pw of the laser beam was changed every 0.2 mW within a range of 5.8 mW to 6.6 mW.

The result of the measurement is shown in a curve B of FIG. 38.

As shown in FIG. 38, the following was recognized. More specifically, in the case in which the power of the laser beam is to be modulated by using a single pulse and the recording mark having the length corresponding to the 3T signal is to be formed on a single recording layer having a reflecting film provided thereon, and the power of the laser beam is to be modulated to form a recording mark in such a manner that a timing for causing the power of the laser beam to rise to be the recording power Pw when forming the recording mark having the length corresponding to the 3T signal on the first L1 recording film and the second L1 recording film in the optical recording medium sample #1 is delayed by 0.2T from a timing for forming the recording marks having the lengths corresponding to the 2T signal and the 4T signal to the 8T signal, the jitter of a regenerative signal obtained by reproducing the recorded data can be reduced more considerably as compared with the case in which the power of the laser beam is modulated to form a recording mark in such a manner that the power of the laser beam rises to be the recording power Pw in the same timing also when the recording marks having the lengths corresponding to the 2T signal to the 8T signal are to be formed as shown in FIGS. 39 and 40.

Accordingly, the following was found. More specifically, also in the case in which the random signal including the 2T signal to the 8T signal is to be recorded on a single recording layer comprising a reflecting film in addition to the case in which the data are to be recorded on the L1 recording layer which is close to the light transmitting layer of the light recording medium comprising the L0 recording layer and the L1 recording layer, the power of the laser beam is modulated in such a manner that the timing for causing the power of the laser beam to rise to be the recording power Pw when modulating the power of the laser beam by using a single pulse to form the recording mark having the length corresponding to the 3T signal is delayed by 0.2T from a timing for forming the recording mark having the lengths corresponding to the 2T signal and the 4T signal to the 8T signal. Thus, it is possible to considerably reduce the jitter of a regenerative signal obtained by reproducing the data.

The invention is not restricted to the above embodiments but various changes can be made without departing from the scope of the invention described in the claims and it is apparent that they are also included within the scope of the invention.

For instance, in the embodiments and the examples, the description has been given to the case in which the power of a laser beam is modulated by using a single pulse to form the recording marks having the lengths corresponding to the 3T signal to the 6T signal. The recording mark having the length corresponding to the 7T signal and the recording mark having the length corresponding to the 8T signal can also be formed corresponding to the recording linear speed by modulating the power of the laser beam using the single pulse and delaying the timing for causing the power of the laser beam to rise to be the recording power Pw from the timing for forming the recording mark having the length corresponding to the 2T signal.

Furthermore, the timing for causing the power of the laser beam to rise to be the recording power Pw when modulating the power of the laser beam by using the single pulse to form the recording mark having the length corresponding to the 3T signal is delayed by 0.2T from the timing for forming the recording mark having the length corresponding to the 2T signal in the recording strategy shown in FIGS. 12 and 13, the recording strategy shown in FIGS. 31 and 32, and the recording strategy shown in FIGS. 36 and 37, the timing for causing the power of the laser beam to rise to be the recording power Pw when modulating the power of the laser beam by using the single pulse to form the recording mark having the length corresponding to the 4T signal is delayed by 0.3T from the timing for forming the recording mark having the length corresponding to the 2T signal in the recording strategy shown in FIGS. 14 and 15, the timing for causing the power of the laser beam to rise to be the recording power Pw when modulating the power of the laser beam by using the single pulse to form the recording mark having the length corresponding to the 5T signal is delayed by 0.3T from the timing for forming the recording mark having the length corresponding to the 2T signal in the recording strategy shown in FIGS. 16 and 17, and the timing for causing the power of the laser beam to rise to be the recording power Pw when modulating the power of the laser beam by using the single pulse to form the recording mark having the length corresponding to the 6T signal is delayed by 0.4T from the timing for forming the recording mark having the length corresponding to the 2T signal in the recording strategy shown in FIGS. 18 and 19. The degree of the delay of the timing for causing the power of the laser beam to rise to be the recording power Pw can be properly determined according to the type of the optical recording medium and is not restricted to the embodiments and the examples.

In the embodiments and the examples, moreover, when the power of the laser beam is modulated by using the single pulse to form the recording mark having the length corresponding to the 3T signal, when the power of the laser beam is modulated by using the single pulse to form the recording mark having the length corresponding to the 4T signal, when the power of the laser beam is modulated by using the single pulse to form the recording mark having the length corresponding to the 5T signal, and when the power of the laser beam is modulated by using the single pulse to form the recording mark having the length corresponding to the 6T signal, the timing for causing the power of the laser beam to rise to be the recording power Pw is delayed from the timing for forming the recording mark having the length corresponding to the 2T signal, and furthermore, the time required for setting the power of the laser beam to be the recording power Pw is shortened. It is not always necessary to delay the timing for causing the power of the laser beam to rise to be the recording power Pw from the timing for forming the recording mark having the length corresponding to the 2T signal and to shorten the time required for setting the power of the laser beam to be the recording power Pw.

In the embodiments, furthermore, when the data are to be recorded on the L0 recording layer 23 and the L1 recording layer 33 in the optical recording medium 10, the power of the laser beam is modulated by using the recording strategy shown in FIGS. 12 and 13, the recording strategy shown in FIGS. 14 and 15, the recording strategy shown in FIGS. 16 and 17 or the recording strategy shown in FIGS. 18 and 19. The L0 layer 20 includes the reflecting film 21, and a heat generated in the region having the recording mark formed therein can be quickly transmitted to the other regions through the reflecting film 21 by the irradiated laser beam. In the case in which the data are to be recorded on the L0 recording layer 23, therefore, it is not always necessary to modulate the power of the laser beam by using the recording strategy shown in FIGS. 12 and 13, the recording strategy shown in FIGS. 14 and 15, the recording strategy shown in FIGS. 16 and 17 or the recording strategy shown in FIGS. 18 and 19.

While the first L0 recording film 23a and the second L0 recording film 23b in the L0 recording layer 23 are formed in contact with each other in the embodiments, moreover, it is preferable that the second L0 recording film 23b of the L0 recording layer 23 should be provided in the vicinity of the first L0 recording film 23a in such a manner that the element contained as the principal component in the first L0 recording film 23a and the element contained as the principal component in the second L0 recording film 23b are mixed to form the recording mark M upon receipt of the irradiation of the laser beam, the first L0 recording film 23a and the second L0 recording film 23b in the L0 recording layer 23 do not need to be formed in contact with each other, and another layer such as a dielectric layer or more may be provided between the first L0 recording film 23a and the second L0 recording film 23b.

While the first L1 recording film 33a and the second L1 recording film 33b in the L1 recording layer 33 are formed in contact with each other in the embodiments, moreover, it is preferable that the second L1 recording film 33b of the L1 recording layer 33 should be provided in the vicinity of the first L1 recording film 33a in such a manner that the element contained as the principal component in the first L1 recording film 33a and the element contained as the principal component in the second L1 recording film 33b are mixed to form the recording mark M upon receipt of the irradiation of the laser beam, the first L1 recording film 33a and the second L1 recording film 33b in the L1 recording layer 33 do not need to be formed in contact with each other, and another layer such as a dielectric layer or more may be provided between the first L1 recording film 33a and the second L1 recording film 33b.

While the first L0 recording film 23a and the first L1 recording film 33a contain Si as a principal component respectively in the embodiments, furthermore, the first L0 recording film 23a and the first L1 recording film 33a do not need to contain Si as the principal component respectively but may contain, as the principal component, an element selected from the group consisting of Ge, Sn, Mg, In, Zn, Bi and Al in place of Si.

While the second L0 recording film 23b and the second L1 recording film 33b contain Cu as a principal component respectively in the embodiments, moreover, the second L0 recording film 23b and the second L1 recording film 33b do not need to contain Cu as the principal component respectively and the second L0 recording film 23b or the second L1 recording film 33b may contain, as the principal component, an element selected from the group consisting of Al, Zn, Ti and Ag in place of Cu, that is, a different element from the element contained as the principal component in the first L0 recording film 23a or the first L1 recording film 33a.

While the first L0 recording film 23a is provided on the light transmitting layer 13 side and the second L0 recording film 23b is provided on the support substrate 11 side in the embodiments, furthermore, it is also possible to provide the first L0 recording film 23a on the support substrate 11 side and to provide the second L0 recording film 23b on the light transmitting layer 13 side.

While the first L1 recording film 33a is provided on the light transmitting layer 13 side and the second L1 recording film 33b is provided on the support substrate 11 side in the embodiments, moreover, it is also possible to provide the first L1 recording film 33a on the support substrate 11 side and to provide the second L1 recording film 33b on the light transmitting layer 13 side.

Although the L1 recording layer 33 includes the first L1 recording film 33a containing Si as the principal component and the second L1 recording film 33b containing Cu as the principal component in the same manner as the L0 recording layer 23 in the embodiments, furthermore, the L1 recording layer 33 does not need to include the first L1 recording film 33a containing Si as the principal component and the second L1 recording film 33b containing Cu as the principal component in the same manner as the L0 recording layer 23 but may be constituted by a recording film having a single layer.

While the optical recording medium 10 comprises the L0 layer 20 and the L1 layer 30 and has two recording layers in the embodiments, moreover, the invention can also be applied to the case in which data are to be recorded on an optical recording medium having three recording layers or more and can also be applied to the case in which data are to be recorded on the optical recording medium having a single recording layer as described in the example 6.

While the description has been given to only the case in which data are to be recorded on a write-once optical recording medium in the embodiments and the examples, moreover, the invention is not restricted to the case in which the data are to be recorded on the write-once optical recording medium but can also be applied to the case in which data are to be recorded on a rewritable optical recording medium. The invention can be widely applied to the case in which data are to be recorded on an optical recording medium irrespective of the layer structure of an optical recording medium for recording data and the type of a recording film.

What is claimed is:

1. A method of recording data on an optical recording medium which irradiates a laser beam having a power modulated as a pulse between at least a recording power and a base power having a lower level than the recording power on the optical recording medium comprising a light transmitting layer and at least one recording layer from the light transmitting layer side and forms a recording mark having a different length on the at least one recording layer to record data,
wherein a timing for causing the power of the laser beam to rise to be the recording power when forming a longer recording mark than the shortest recording mark on the at least one recording layer by using a laser beam modulated by a single pulse is delayed from a timing for causing the power of the laser beam to rise to be the recording power when forming the shortest recording mark, thereby forming the recording mark on the at least one recording layer.

2. The method of recording data on an optical recording medium according to claim 1, wherein the power of the laser beam is modulated among the recording power, the base power and an intermediate power having a level which is lower than the recording power and is higher than the base power.

3. The method of recording data on an optical recording medium according to claim 1, wherein the optical recording medium comprises a plurality of recording layers.

4. The method of recording data on an optical recording medium according to claim 3, wherein at least the recording layers excluding the most distant recording layer from the light transmitting layer include: a first recording film containing, as a principal component, an element selected from the group consisting of Si, Ge, Sn, Mg, In, Zn, Bi and Al, and a second recording film provided in the vicinity of the first recording film and containing, as a principal component, an element selected from the group consisting of Cu, Al, Zn, Ti and Ag, and have such a structure that the element contained as the principal component in the first recording film and the element contained as the principal component in the second recording film are mixed to form a recording mark when the laser beam is irradiated.

5. The method of recording data on an optical recording medium according to claim 4, wherein the first recording film contains Si as a principal component and the second recording film contains Cu as a principal component.

6. The method of recording data on an optical recording medium according to claim 4, wherein the second recording film is formed in contact with the first recording film.

7. The method of recording data on an optical recording medium according to claim 1, wherein a laser beam having a wavelength of 350 nm to 450 nm is irradiated to record data.

8. The method of recording data on an optical recording medium according to claim 1, wherein a laser beam is irradiated by using an objective lens having a numerical aperture NA to satisfy λ/NA≦640 nm and a laser beam having a wavelength λ through the objective lens, thereby recording data on the optical recording medium.

9. An apparatus for recording data on an optical recording medium comprising:
a laser beam source for emitting a laser beam;
an objective lens;
laser power controller configured to modulate a power of the laser beam emitted from the laser beam source as a pulse between at least a recording power and a base power having a lower level than the recording power;
a memory; and
a control unit controlling a whole operation,
wherein a timing for causing the power of the laser beam to rise to be the recording power when forming a longer recording mark than the shortest recording mark on a recording layer of the optical recording medium by using a laser beam modulated by a single pulse is delayed from a timing for causing the power of the laser beam to rise to be the recording power when forming the shortest recording mark and
the control unit can build a recording strategy determined to form a recording mark on the at least one recording layer based on ID data recorded on the optical recording medium stored in the memory.

10. The apparatus for recording data on an optical recording medium according to claim 9, wherein the laser beam control means is constituted to modulate the power of the laser beam among the recording power, the base power and an intermediate power having a level which is lower than the recording power and is higher than the base power.

11. The apparatus for recording data on an optical recording medium according to claim 9, wherein the laser beam source is constituted to emit a laser beam having a wavelength of 350 nm to 450 nm.

12. The apparatus for recording data on an optical recording medium according to claim 9, wherein a wavelength λ of the laser beam emitted from the laser beam source and a numerical aperture NA of the objective lens satisfy λ/NA≦640 nm.
